(19) United States
(12) Patent Application Publication
(10) Pub. No.: US 2012/0262109 A1
(43) Pub. Date: Oct. 18, 2012

(54) BATTERY PACK WITH OUTPUT CONNECTORS

(76) Inventors: Shoichi TOYA, Minamiawaji-shi (JP); Toshiki Nakasho, Sumoto-shi (JP)

(21) Appl. No.: 13/443,203

(22) Filed: Apr. 10, 2012

(30) Foreign Application Priority Data
Apr. 12, 2011 (JP) 2011-88617

(51) Int. Cl. H02J 7/00

(52) U.S. Cl. 320/108

(57) ABSTRACT

The casing 2 has a planar bottom plate 22, a top plate 21 disposed opposite and separated from the bottom plate 22, and perimeter walls 23 that establish an enclosed storage space 25. The internal battery 1, the receiving coil 5, and the circuit board 4 are disposed in the storage space 25. The internal battery 1 is circular cylindrical batteries 1A disposed parallel to the bottom plate 22 along the inside surfaces of perimeter side-walls 23A. The receiving coil 5 is a planar coil disposed on the inside surface of the bottom plate 22 at the bottom of the storage space 25. The circuit board 4 is disposed inside the top plate 21 separated from the receiving coil 5, and a heat dissipating region 26 is established in the space surrounded by the circuit board 4, the receiving coil 5, and the internal battery 1.

### BACKGROUND OF THE INVENTION

1. Field of the Invention

The present invention relates to a battery pack housing batteries (or a single battery) that can be charged, having the capability to charge those internal batteries via magnetic induction, and provided with output connectors (or a single connector) for optimal use as a portable power source to supply power to externally connected electronic equipment.

2. Description of the Related Art

A battery pack and charging pad (charging stand, charging plate, charging cradle) have been developed to charge batteries housed in the battery pack by transmitting power via magnetic induction from a transmitting coil (power supply coil, primary coil) to a receiving coil (induction coil, secondary coil).

Refer to Japanese Laid-Open Patent Publication 2010-98,861.

In the charging apparatus cited in JP 2010-98,861, the charging pad houses a transmitting coil driven by an alternating current (AC) power source, and the battery pack houses a receiving coil that magnetically couples with the transmitting coil. The battery pack also houses circuitry to rectify the AC power induced in the receiving coil and supply that power to the batteries for charging. With this arrangement, the battery pack can be placed on the charging pad to charge the batteries in a contactless (wireless) manner.

A charging system that uses magnetic induction to charge rechargeable batteries in a contactless manner can conveniently charge a battery pack placed on the charging pad without having to make contact connections. Since rechargeable batteries can be charged by wireless power transmission without requiring standardized contact terminals, the system is particularly adaptable for applications such as a coin-operated system available to the general public to charge batteries for a time period set by coin insertion.

FIG. 1 is a cross-section view showing the battery pack 200 cited in JP 2010-98,861 placed on the charging pad 290. The battery pack 200 has a receiving coil 205 disposed in the bottom of the casing 202, and a rectangular internal battery 201 lies on top of that receiving coil 205. This battery pack 200 has the drawback that the internal battery 201, which is progressively heated during charging, is subject to further temperature rise due to heat emanating from the receiving coil 205 and the circuit board. If the charging current is set to a low value to limit internal battery 201 heating, charging time increases and the battery pack 200 cannot be quickly charged.

The present invention was developed with the object of correcting these types of drawbacks. Thus, it is a primary object of the present invention to provide a battery pack with output connectors (or a single connector) that can be connected to, and used to charge portable electronic equipment such as a mobile phone (mobile telephone, cell-phone, cellular telephone), that can charge the internal batteries by wireless power transmission via magnetic induction for reliable charging with no contact resistance problems, and that can rapidly charge the internal rechargeable batteries while limiting battery temperature rise.

### SUMMARY OF THE INVENTION

The battery pack with output connectors of the present invention is provided with a receiving coil 5 that receives power from a transmitting coil 105 when placed on a charging pad 110 having a transmitting coil 105 that transmits charging power via magnetic induction, internal batteries 1 that are charged by power induced in the receiving coil 5, output connectors 8 for use as a power source to output internal battery 1 power to the outside, a circuit board 4 carrying a charging circuit 50 to charge the internal batteries 1 with power induced in the receiving coil 5, and a casing 2, 62 to house the circuit board 4, the receiving coil 5, and the internal batteries 1. The casing 2, 62 has a planar bottom plate 22, 82 for placement on the charging pad 110, a top plate 21, 81 disposed opposite and separated from the bottom plate 22, 82, and perimeter walls 23, 83 made up of side-walls 23A, 83A and end-panels 23B, 83B along the sides and ends of the bottom plate 22, 82 and top plate 21, 81. Storage space 25, 85 is established in the region enclosed by the bottom plate 22, 82, the top plate 21, 81, and the perimeter walls 23, 83; and the internal batteries 1, the receiving coil 5, and the circuit board 4 are disposed in the storage space 25, 85. The internal batteries 1 are circular cylindrical batteries 1A disposed inside the storage space 25, 85 lying parallel to the bottom plate 22, 82 along the inside surfaces of the side-walls 23A, 83A. The receiving coil 5 is a flat (planar) coil disposed on the inside surface of the bottom plate 22, 82, which is the bottom of the storage space 25, 85. The circuit board 4 is disposed inside the top plate 21, 81 separated from the receiving coil 5, and a heat dissipating region 26, 86 is established inside the battery pack surrounded by the circuit board 4, the receiving coil 5, and the internal batteries 1.

The output connectors of the battery pack described above can be connected to portable electronic equipment such as a mobile phone to charge that device. Further, the internal batteries of the battery pack can be charged by wireless power transmission via magnetic induction for reliable charging with no contact resistance concerns. This is because the receiving coil housed in the battery pack magnetically couples with the transmitting coil in the charging pad to transmit power and charge the internal batteries in a contactless manner. This battery pack has the characteristic that the internal rechargeable batteries can be rapidly charged while limiting battery temperature rise. This is because the internal batteries are circular cylindrical batteries disposed in the storage space parallel to the bottom plate on the inside surfaces of the side-walls, the planar receiving coil is disposed at the bottom of the storage space on the inside surface of the bottom plate, and the circuit board is disposed inside the top plate separated from the receiving coil. This arrangement establishes a heat dissipating region that is surrounded by the circuit board, the receiving coil, and the internal batteries. In a battery pack with this structure, heat radiated by the receiving coil and circuit board can be dissipated in the heat dissipating region, thermal coupling between the circular cylindrical internal batteries and the receiving coil can be minimized, and internal battery temperature rise due to heat emitted by the receiving coil and circuit board can be effectively prevented. Reducing internal battery temperature rise achieves the characteristic that temperature-related battery degradation is suppressed allowing rapid charging with high currents to fully-charge the batteries in a short time period.

In the battery pack with output connectors of the present invention, cushion material 7 can be disposed between the receiving coil 5 and the circular cylindrical batteries 1A. In this battery pack, the cushion material can put the receiving coil in close contact with the bottom plate. As a result, when the battery pack is placed on the charging pad, the receiving coil can be put in even closer proximity with the transmitting coil to allow efficient charging of the internal batteries. In addition, since the cushion material blocks heat transfer between the receiving coil and the internal batteries, internal battery temperature rise due to receiving coil heat emission can be prevented in an ideal manner.

In the battery pack with output connectors of the present invention, the circuit board 4 can be disposed below the tops of the internal batteries 1, which is below the level of a line tangent to the tops of the circular cylindrical batteries 1A. In this battery pack, the circuit board can be disposed in the storage space with elements such as a push-button switch and electronic components mounted on its upper surface.

In the battery pack with output connectors of the present invention, the planar receiving coil 5 can be disposed outside the bottoms of the internal batteries 1, which is below the level of a line tangent to the bottoms of the circular cylindrical batteries 1A. In this battery pack, the receiving coil is separated from the circular cylindrical internal batteries to allow further reduction in battery temperature increase due to receiving coil heating.

In the battery pack with output connectors of the present invention, a pair of internal batteries 1 can be disposed in the storage space 25 of the casing 2, and each battery 1 can be disposed in a side of the storage space 25 to establish the heat dissipating region 26 between the pair of internal batteries 1. In this battery pack, since the heat dissipating region is established between two internal batteries, charge capacity can be increased via the two batteries while keeping the casing outline compact.

In the battery pack with output connectors of the present invention, a pair of internal batteries 1 can be disposed in the sides of the casing 2 storage space 25, and the receiving coil 5 can be disposed between peaks at the bottom of the internal batteries 1. In this battery pack, since the receiving coil is disposed between the bottom peaks of the two internal batteries, the receiving coil can be housed at the bottom of the storage space without increasing casing size in the vertical direction (depth).

In the battery pack with output connectors of the present invention, a single internal battery 1 can be disposed in one side of the casing 62 storage space 85, and the heat dissipating region 86 can be established at the side of the internal battery 1. In this battery pack, since the heat dissipating region is surrounded by the receiving coil, the circuit board, the internal battery, and one casing side-wall, the heat dissipating region can dissipate heat even more efficiently. This is because part of the heat dissipating region is coincident with a casing side-wall that can radiate heat to the outside.

In the battery pack with output connectors of the present invention, a push-button switch 16 can be mounted on the upper surface of the circuit board 4, and an operating section 12 to turn the push-button switch 16

ON and OFF can be provided in the top plate 21, 81 of the casing 2, 62 above the push-button switch 16. Since a push-button switch operating section is provided in the top plate of this battery pack, the operator can conveniently activate the push-button switch. The above and further objects of the present invention as well as the features thereof will become more apparent from the following detailed description to be made in conjunction with the accompanying drawings.

### BRIEF DESCRIPTION OF THE DRAWINGS

FIG. 1 is a vertical cross-section view of an apparatus for charging portable electronic equipment previously submitted for patenting by the present applicant;

FIG. 2 is an oblique view showing a battery pack for an embodiment of the present invention being placed on a charging pad;

FIG. 3 is a block diagram showing a battery pack for an embodiment of the present invention placed on a charging pad;

FIG. 4 is an oblique view of a battery pack for the first embodiment of the present invention;

FIG. 5 is an oblique view from below and behind the battery pack shown in FIG. 4;

FIG. 6 is a cross-section through the line VI-VI on the battery pack shown in FIG. 4;

FIG. 7 is a cross-section through the line VII-VII on the battery pack shown in FIG. 4;

FIG. 8 is a cross-section through the line VIII-VIII on the battery pack shown in FIG. 4;

FIG. 9 is a cross-section through the line IX-IX on the battery pack shown in FIG. 4;

FIG. 10 is an exploded oblique view of the battery pack shown in FIG. 4;

FIG. 11 is an exploded oblique view from below the battery pack shown in FIG. 10;

FIG. 12 is an exploded oblique view showing the internal batteries joined with the insulating holder of the battery pack shown in FIG. 10;

FIG. 13 is an exploded oblique view from below the battery pack shown in FIG. 12;

FIG. 14 is a block diagram of a battery pack for an embodiment of the present invention;

FIG. 15 is an oblique view of a battery pack for the second embodiment of the present invention;

FIG. 16 is an oblique view from below and behind the battery pack shown in FIG. 15;

FIG. 17 is a cross-section through the line XVII-XVII on the battery pack shown in FIG. 15;

FIG. 18 is a cross-section through the line XVIII-XVIII on the battery pack shown in FIG. 15;

FIG. 19 is an exploded oblique view of the battery pack shown in FIG. 15;

FIG. 20 is an exploded oblique view from below the battery pack shown in FIG. 19;

FIG. 21 is an exploded oblique view showing the internal battery joined with the insulating holder of the battery pack shown in FIG. 20; and

FIG. 22 is an exploded oblique view from behind and above the battery pack shown in FIG. 21.

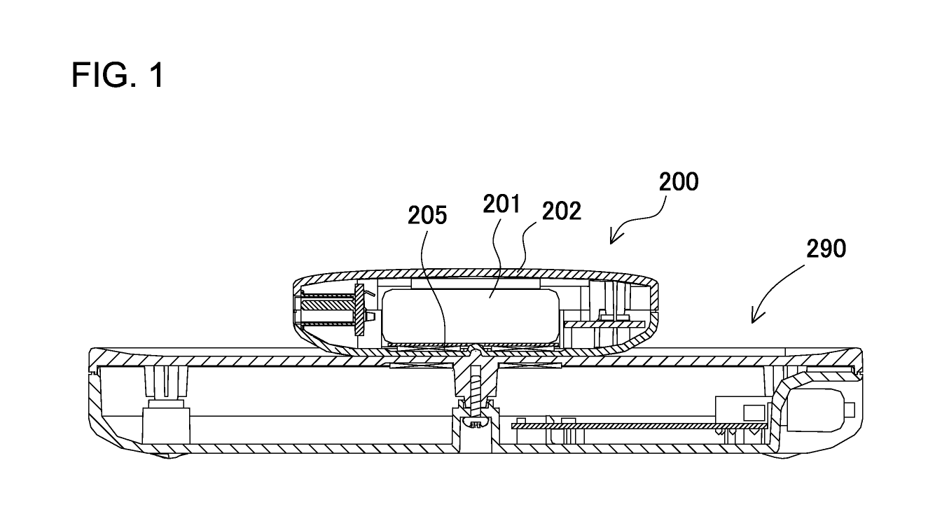

### DETAILED DESCRIPTION OF THE EMBODIMENTS

The following describes embodiments of the present invention based on the figures. However, the following embodiments are merely specific examples of a battery pack with output connectors representative of the technology associated with the present invention, and the battery pack with output connectors of the present invention is not limited to the embodiments described below. Further, components cited in the claims are in no way limited to the components in the embodiments.

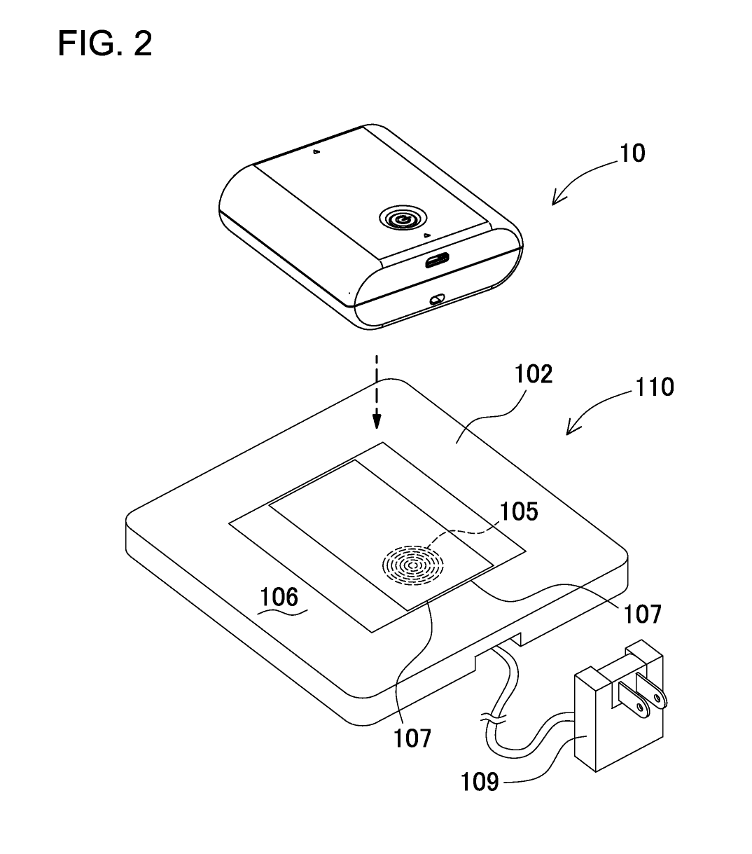

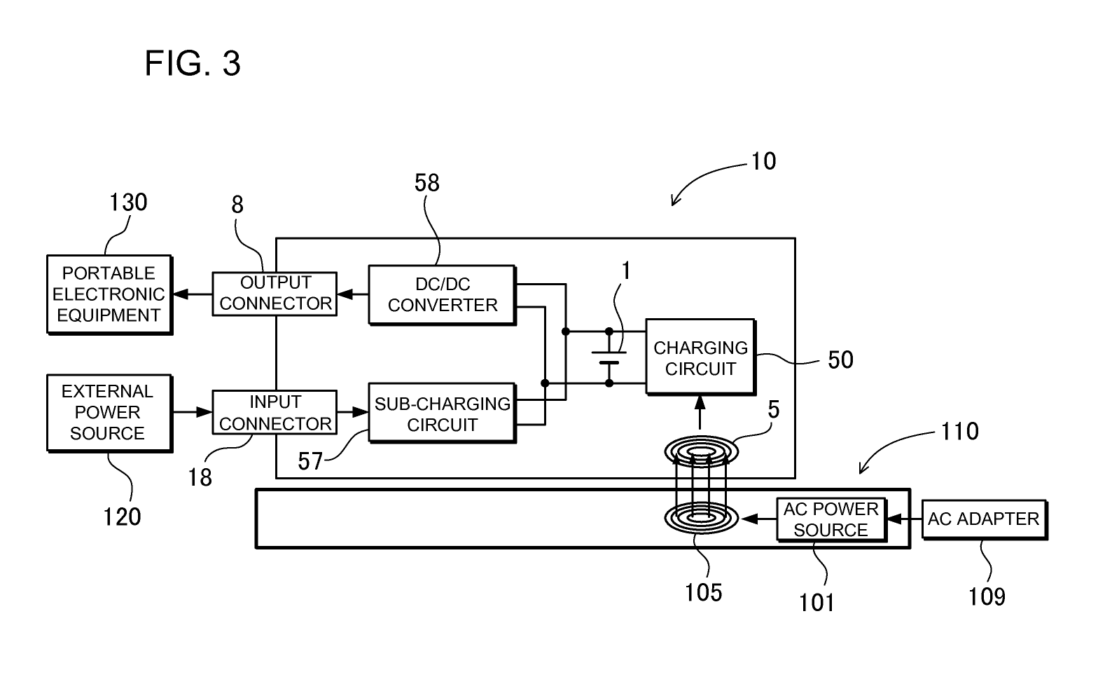

As shown in FIGS. 2 and 3, the battery pack of the present invention is provided with internal batteries 1 charged by placing the battery pack on a charging pad 110 and transmitting power via magnetic induction, or by direct connection to an external power source 120. Further, the battery pack is provided with output connectors 8 for use as a power source to output power from the charged internal batteries 1 to external devices.

(Charging Pad)

As shown in FIGS. 2 and 3, the charging pad 110, which charges battery pack internal batteries 1 via magnetic induction, houses a transmitting coil 105 to supply power to the battery pack 10 by magnetic induction. The battery pack 10 is provided with a receiving coil 5 that magnetically couples with the transmitting coil 105, and the capability to convert AC power induced in the receiving coil 5 to direct current (DC) to charge the batteries.

The charging pad 110 shown in FIGS. 2 and 3 is provided with an AC power source 101 that supplies the transmitting coil 105 with AC power, and an external case 102 that houses the AC power source 101 and the transmitting coil 105. The top of the external case 102 is provided with a flat upper plate 106 to place a battery pack 10 in a removable manner. The charging pad 110 in FIG. 2 has an upper plate 106 with an outline that is larger than the outline of the battery pack 10. This charging pad 110 allows the battery pack 10 to be stably placed on the upper plate 106. The transmitting coil 105 is disposed on the bottom surface of the upper plate 106. The transmitting coil 105 is mounted along the bottom surface of the upper plate 106, or is installed to move along the bottom surface of the upper plate.

For an external case 102 with the transmitting coil 105 mounted on the bottom of the upper plate 106, the location of the transmitting coil 105, which is the battery pack 10 placement position, is marked for efficient power transmission from the transmitting coil 105 to the receiving coil 5 via magnetic induction. The upper plate 106 in FIG. 2 has position indicating marks 107 showing the proper battery pack 10 placement location. The external case 102 of the figure has indicating marks 107 printed on the top of the upper plate 106 showing the battery pack 10 outline. When the battery pack 10 is placed on the charging pad 110 coincident with the outline of the indicating marks 107, it is in the proper position. A plurality of position indicating marks 107 is printed on the upper plate 106 of the figure to allow a plurality of different types of battery packs 10 to be placed in the proper position on the charging pad 110. This charging pad 110 has the characteristic that various different types of battery packs 10 can be properly positioned on the charging pad 110.

Although not illustrated, a charging pad, which moves the transmitting coil along the bottom of the upper plate, detects the position of the receiving coil of a battery pack placed on the upper plate, and moves the transmitting coil in close proximity to the receiving coil. The battery pack does not need to be placed in a specific position on this type of charging pad. This is because the transmitting coil can be moved close to the receiving coil of a battery pack placed in any position on the upper plate to efficiently transmit power via magnetic induction.

To dispose the transmitting coil 105 in horizontal orientation on the bottom of the upper plate 106, a spirally wound planar coil is used. The transmitting coil can be insertion molded to embed it in the upper plate. A charging pad with the transmitting coil insertion molded into the upper plate can be made with an overall thin outline. Further, insertion molding firmly attaches the transmitting coil to the external case, and disposing the transmitting coil close to the top surface of the upper plate reduces the gap between the receiving coil to allow efficient transmission of AC power to the receiving coil. The inductance of the transmitting coil is set to an optimum value depending on the frequency of the AC power. For example, the inductance of a transmitting coil supplied with AC power having a frequency between 100 kHz and 500 kHz is set between tens of μH to several mH. However, the AC power supplied to the transmitting coil is not limited to frequencies in the above range. This is because power can be transmitted to the battery pack via magnetic induction when the transmitting coil is supplied with AC power having frequencies below 100 kHz and above 500 kHz as well. Power can be transmitted efficiently to the receiving coil by magnetic induction using a transmitting coil that has low inductance for high frequency AC power and high inductance for low frequency AC power.

The AC power source 101 converts input power to AC power having the proper frequency for output to the transmitting coil 105. DC power is input to the AC power source 101 from an AC adapter 109, or from a connector such as a USB connector. In addition, commercial AC power can be input to the AC power source, converted to the transmitting coil frequency, and output to the transmitting coil. The AC power source 101 converts input DC or AC power to AC power having the prescribed frequency and voltage for output to the transmitting coil 105. An AC power source 101 that inputs DC power from an AC adapter 109 or connector converts the DC to AC with a DC/AC inverter. An AC power source that inputs commercial AC power converts the input AC to DC with a rectifying circuit, converts the DC output from the rectifying circuit to AC with a DC/AC inverter, and outputs the converted AC to the transmitting coil 105.

The AC power source 101 detects placement of a battery pack 10 on the charging pad 110 or the operator turns ON a power switch (not illustrated) to output AC power to the transmitting coil 105. An AC power source 101 that detects battery pack 10 placement on the charging pad 110 is provided with circuitry (not illustrated) to detect the receiving coil 5 in the battery pack 10. In addition, the AC power source 101 detects full-charge of the batteries 1 housed in the battery pack 10 and stops outputting AC power to the transmitting coil 105. The AC power source 101 detects the change in transmitting coil 105 current to determine full-charge of the internal batteries 1. When the batteries 1 housed in the battery pack 10 reach full-charge, the receiving coil 5 switches to a no-load condition and receiving coil 5 current is essentially cut-off. When receiving coil 5 current cuts-off, transmitting coil 105 current also decreases. Consequently, full-charge of the internal batteries 1 in the battery pack 10 can be determined by detecting a drop in transmitting coil 105 current below a set value.

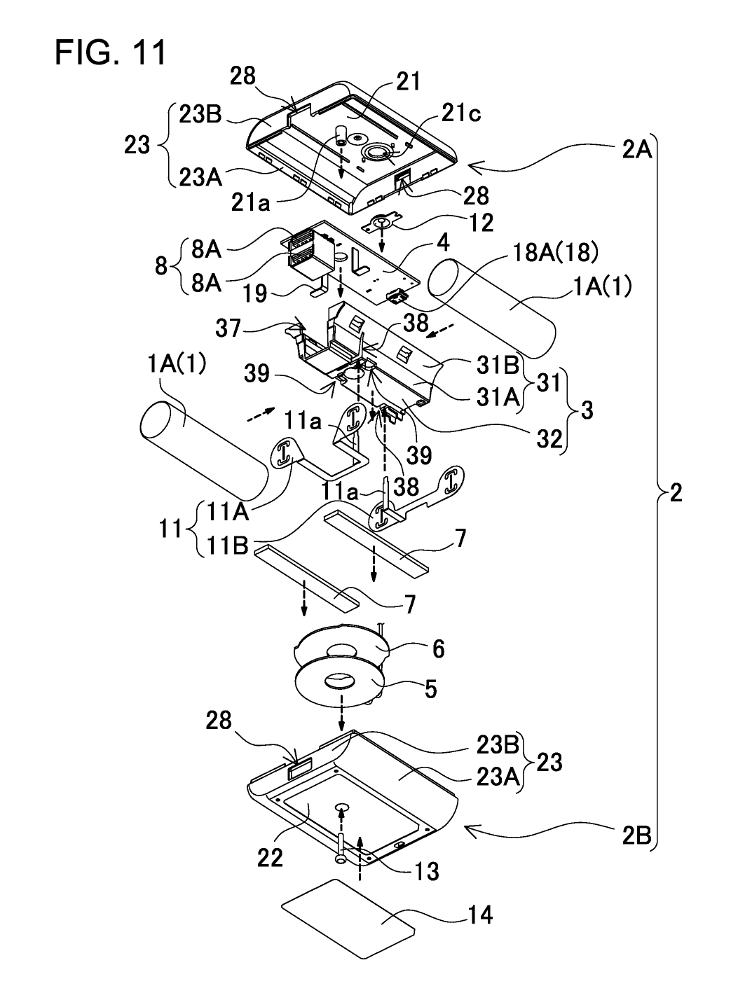

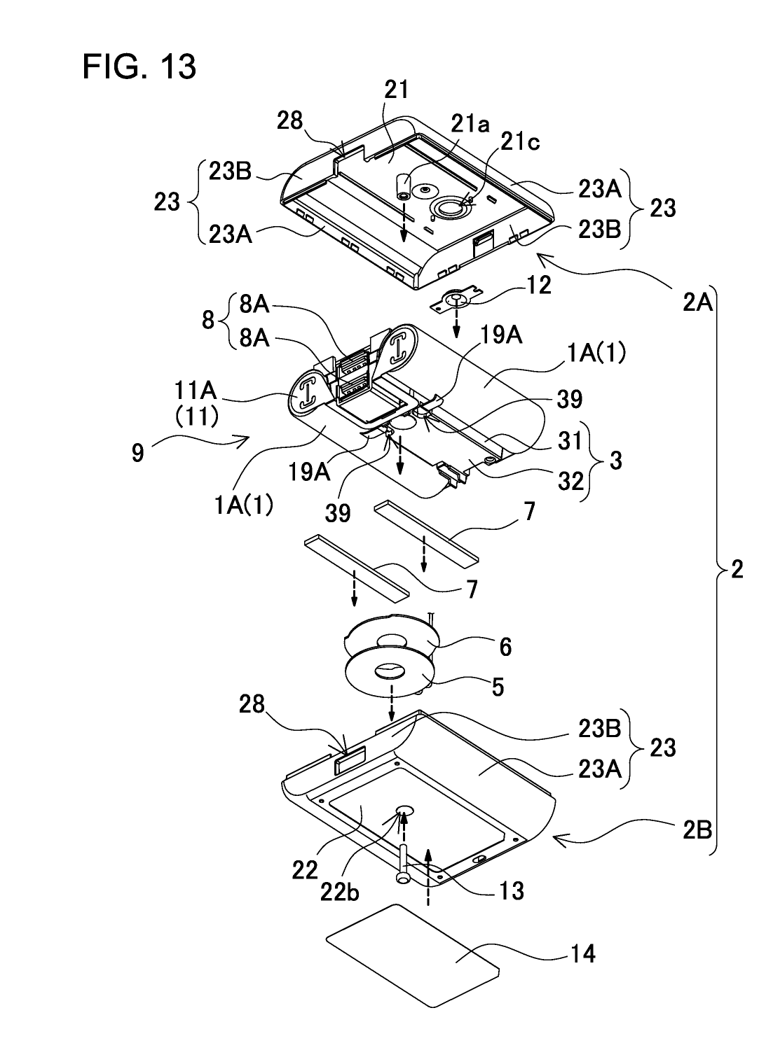

As shown in FIGS. 2-14, the battery pack 10 is provided with a receiving coil 5 that receives power from a transmitting coil 105 when placed on a charging pad 110 having a transmitting coil 105 that transmits charging power via magnetic induction, internal batteries 1 that are charged by power induced in the receiving coil 5, output connectors 8 for use as a power source to output internal battery 1 power to the outside, a circuit board 4 carrying a charging circuit 50 to charge the internal batteries 1 with power induced in the receiving coil 5, and a casing 2 to house the circuit board 4, the receiving coil 5, and the internal batteries 1. Further, the battery pack 10 houses a sub-charging circuit 57 that connects with an external power source 120 to charge the batteries 1.

(Casing)

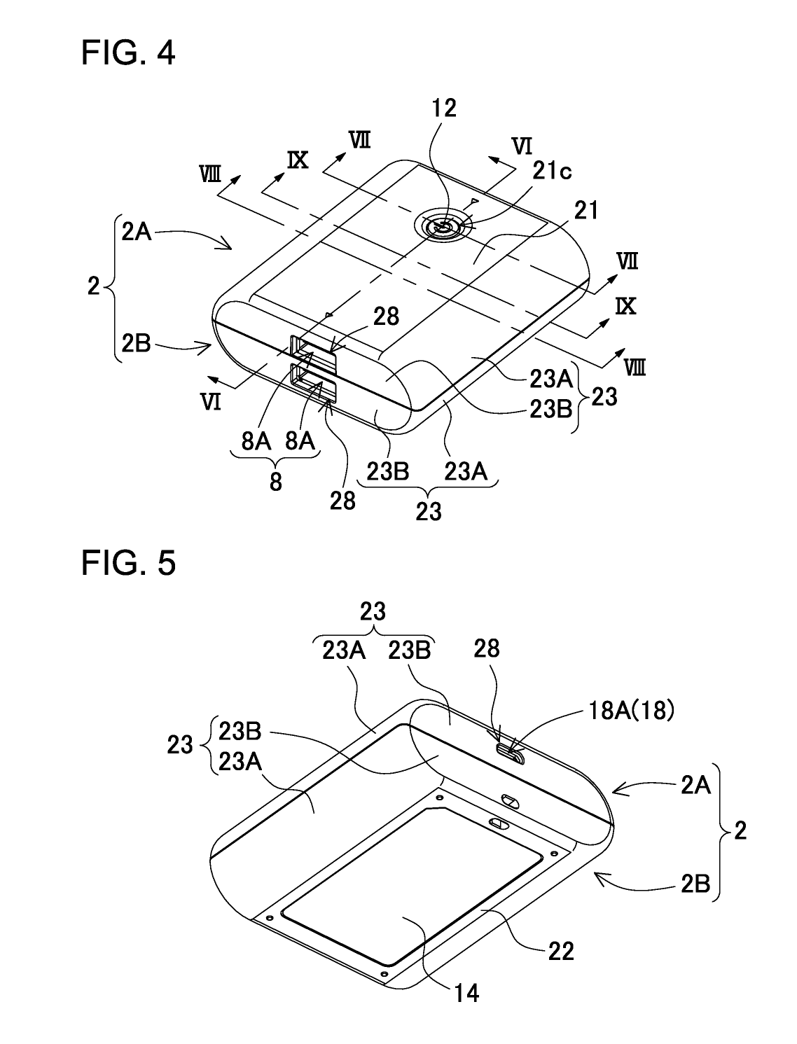

The casing 2 is made up of a plastic upper case 2A and lower case 2B that join to establish storage space 25 inside. The casing 2 of FIGS. 4-13 has a planar bottom plate 22 for placement on the charging pad 110, a top plate 21 disposed opposite and separated from the bottom plate 22, and perimeter walls 23 made up of side-walls 23A and end-panels 23B along the sides and ends of the bottom plate 22 and top plate 21. The storage space 25 is established in the region enclosed by the bottom plate 22, the top plate 21, and the perimeter walls 23.

The bottom plate 22 is formed as a single-piece with the lower case 2B, and the top plate 21 is formed as a single-piece with the upper case 2A. Further, the upper case 2A is formed as a single-piece with the upper halves of the perimeter walls 23, and the lower case 2B is formed as a single-piece with the lower halves of the perimeter walls 23. The upper case 2A and lower case 2B are joined along the boundaries of the upper and lower halves of the perimeter walls 23 establishing the storage space 25 inside. The internal batteries 1, receiving coil 5, and circuit board 4 are disposed inside the storage space 25.

The internal batteries 1, which are circular cylindrical batteries 1A, the planar receiving coil 5, and the circuit board 4 are disposed in the storage space 25 of the casing 2 in a manner that establishes a heat dissipating region 26 within the storage space 25. To establish the heat dissipating region 26, the circular cylindrical batteries 1A are disposed along the inside surfaces of the side-walls 23A lying parallel to the bottom plate 22, the planar receiving coil 5 is disposed at the bottom of the storage space 25 on the inside surface of the bottom plate 22, and the circuit board 4 is disposed separated from the receiving coil 5 inside the top plate 21. Specifically, the receiving coil 5 is disposed at the bottom, the circuit board 4 is disposed at the top, and the circular cylindrical batteries 1A are disposed at the sides of the storage space 25 to form a heat dissipating region 26 that is surrounded by the receiving coil 5, circuit board 4, and internal batteries 1.

(Internal Batteries)

The internal batteries 1 are lithium ion circular cylindrical batteries 1A. The lithium ion batteries can be 18650 circular cylindrical batteries 1A, which are batteries widely adopted in various applications such as the power source for laptop computers. However, the battery pack of the present invention is not limited to use of this type of battery. A battery pack 10 with lithium ion internal batteries 1 can be made with a large charging capacity in a compact outline. The internal batteries can also be any type of rechargeable circular cylindrical batteries other than lithium ion batteries such as nickel-hydride batteries.

(Receiving Coil)

The receiving coil 5 is a planar coil with wire wound in a spiral configuration. The planar receiving coil 5 is wound as a spiral with one or a plurality of layers having an overall disc-shape with a circular outline. The surface of the receiving coil 5 facing the circuit board 4 is covered with a shielding plate 6. The shielding plate 6 shields the circuit board 4 and internal batteries 1 from the AC magnetic field of the receiving coil 5.

(Cushion Material)

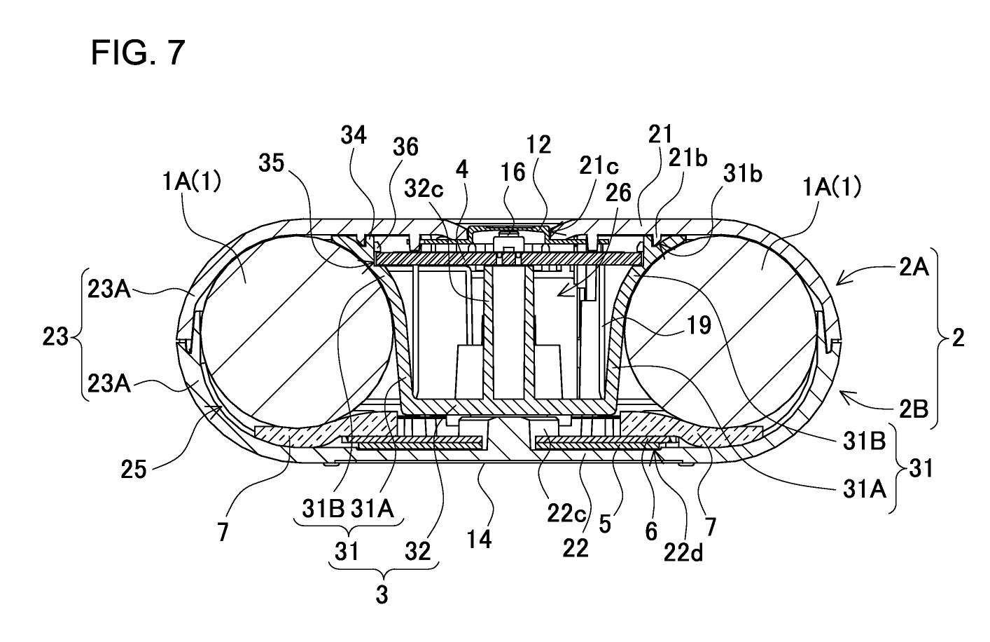

The battery pack 10 in FIGS. 7-13 has cushion material 7 disposed between the receiving coil 5 and the circular cylindrical batteries 1A. The cushion material 7 puts the receiving coil 5 in close contact with the bottom plate 22, and also blocks the transfer of heat between the receiving coil 5 and the internal batteries 1. A receiving coil 5 that is pressed by cushion material 7 into close contact with the bottom plate 22 is positioned closer to the transmitting coil 105 for efficient battery 1 charging when the battery pack 10 is in place on the charging pad 110. Cushion material 7 that blocks heat transfer between the receiving coil 5 and the internal batteries 1 stops battery 1 temperature rise due to heat emitted by the receiving coil 5 in an ideal manner. However, the receiving coil can also be adhesively attached to the inside surface of the bottom plate via materials such as adhesive bond or double-sided tape.

(Circuit Board)

As shown in FIGS. 7-9, the circuit board 4 is disposed below a line tangent to the tops of the circular cylindrical batteries 1A, which are the internal batteries 1. Accordingly, elements such as electronic components and a push-button switch 16 are mounted on the upper surface of the circuit board 4. Further, the planar receiving coil 5 is disposed below a line tangent to the bottoms of the circular cylindrical batteries 1A. This separates the circular cylindrical batteries 1A from the receiving coil 5 to further reduce battery 1 temperature rise caused by the receiving coil 5.

(Output Connectors, Input Connector)

As shown in FIGS. 3-14, the battery pack 10 is provided with output connectors 8 to supply power to externally connected portable electronic equipment 130. The battery pack 10 of the figures has USB connectors 8A as the output connectors 8. A USB connector 8A, which is an output connector 8, is a standardized USB connector that outputs power when the operating section 12 is pressed. However, the output connectors are not limited to USB connectors. Any connector other than a USB connector that can connect to external portable electronic equipment and supply power can also be used as an output connector. For example, a connector that connects to a mobile phone power supply terminal can be used as an output connector. In addition, the battery pack 10 of the figures is provided with an input connector 18 to charge the internal batteries 1. The output connectors 8 and input connector 18 of the figures are mounted on the circuit board 4 to dispose them in fixed positions inside the storage space 25.

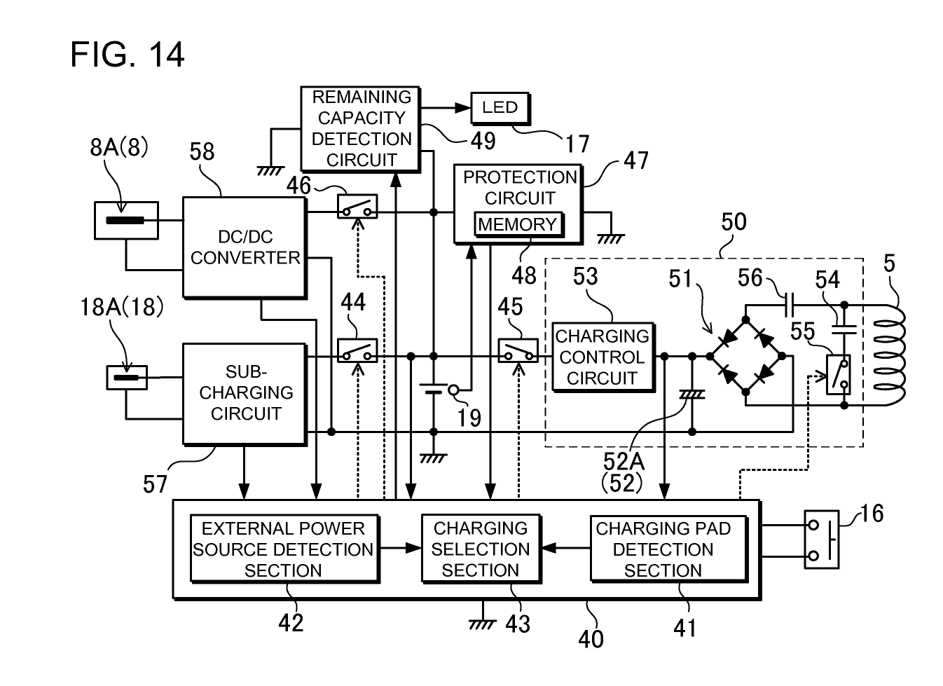

As shown in FIG. 14, the circuit board 4 carries a charging circuit 50 that converts AC power induced in the receiving coil to DC to charge the internal batteries 1, a sub-charging circuit 57 that charges the internal batteries 1 with power input from an external power source 120, a DC/DC converter 58 that stabilizes internal battery 1 voltage and outputs a constant voltage, and a control circuit 40 that controls internal battery 1 charging conditions and output connector 8 discharging conditions.

(Charging Circuit)

The charging circuit 50 is provided with a rectifying circuit 51 that rectifies AC induced in the receiving coil 5 converting it to DC, a smoothing capacitor 52A that makes up a smoothing circuit 52 to smooth ripple current in the DC rectified by the rectifying circuit 51, and a charging control circuit 53 that charges the internal batteries 1 with DC smoothed by the smoothing circuit 52.

The charging circuit 50 charges the internal batteries 1 with appropriate voltage and current. The charging circuit 50 in a battery pack 10 with lithium ion internal batteries 1 has a charging control circuit 53 that is a constant voltage-constant current circuit for charging the internal batteries 1 with a constant voltage and a constant current. The charging control circuit in a battery pack with internal batteries such as nickel hydride batteries or alkaline batteries is a constant current circuit.

(Sub-Charging Circuit)

The sub-charging circuit 57 charges the internal batteries 1 with power input from an external power source 120. In a battery pack with lithium ion internal batteries 1, the sub-charging circuit 57 charges the internal batteries 1 via constant voltage-constant current charging. In a battery pack with internal batteries that are nickel hydride or nickel cadmium batteries, the sub-charging circuit charges the internal batteries with constant current charging. Further, when the sub-charging circuit 57 detects full-charge of the internal batteries 1, it halts charging. The battery pack 10 of the figures is provided with an input connector 18 to input power from an external power source 120 to the sub-charging circuit 57. The input connector 18 shown in the figures is a mini- or micro-USB connector 18A. However, any input connector that can input power from an external power source, other than a mini- or micro-USB connector, can also be used. For example, a connector such as the power receptacle for an adapter jack connected to an AC adapter can also be used.

When an external power source 120 is connected to the input connector 18, the sub-charging circuit 57 can detect that connection from input current or voltage. This is because power is supplied from the external power source 120 to the battery pack 10 when the external power source 120 is connected. When power is input from the external power source 120, the sub-charging circuit 57 charges the internal batteries 1 with power from the external power source 120. However, instead of providing a special-purpose input connector dedicated to battery charging, the output connectors can serve both to input external power and to output power to the outside. For example, this type of battery pack can connect the output connectors to the sub-charging circuit or the DC/DC converter via switching, and the output connectors can be connected to either the sub-charging circuit or the DC/DC converter by switch control.

When an external power source 120 is connected to the input connector 18 and the battery pack is placed on the charging pad 110, the battery pack is configured to charge the internal batteries 1 by either the external power source 120 or the charging pad 110. The control circuit 40 in FIG. 14 is provided with a charging pad detection section 41 that detects placement of the battery pack 10 on the charging pad 110, an external power source detection section 42 that detects connection or charging by an external power source 120, and a charging selection section 43 that selects internal battery 1 charging by either the charging pad 110 or the external power source 120 depending on signals from the charging pad detection section 41 and the external power source detection section 42.

When the battery pack 10 is placed on the charging pad 110 and an external power source 120 is also connected, the control circuit 40 via the charging selection section 43 controls internal battery 1 charging with either the charging pad 110 or the external power source 120. In the case where the battery pack 10 is placed on the charging pad 110 and the external power source 120 is connected, namely, when the internal batteries 1 can be charged by either the charging pad 110 or the external power source 120, the control circuit 40 preferably charges the internal batteries 1 only with power supplied from the external power source 120 and not with power transmitted from the charging pad 110. However, when the battery pack 10 is placed on the charging pad 110 and the external power source 120 is connected, the internal batteries 1 can also be charged only with power transmitted from the charging pad 110 and not with power supplied from the external power source 120. In that case, the switch 44 is controlled OFF to cut-off power from the sub-charging circuit 57.

The control circuit 40 charging pad detection section 41 detects placement of the battery pack 10 on the charging pad 110, or charging by the charging pad 110. As its power supply voltage, the control circuit 40 operates by power output from the rectifying circuit 51, which converts receiving coil 5 output to DC, and does not operate by power supplied from the internal batteries 1. Specifically, the control circuit 40 does not consume operating power from the internal batteries 1, but rather operates on power supplied by magnetic induction from the charging pad 110. Accordingly, when the battery pack 10 is placed on the charging pad 110, the control circuit 40 is activated and becomes operational. The charging pad detection section 41 detects placement of the battery pack 10 on the charging pad 110 by detecting control circuit 40 activation. This charging pad detection section 41 can detect placement on the charging pad 110 with a simple circuit structure. However, the charging pad detection section could also detect placement on the charging pad by receiving a signal sent from charging pad.

The external power source detection section 42 detects external power source 120 connection or internal battery 1 charging by the external power source 120. The external power source detection section 42 detects external power source 120 connection or charging while contactless charging is in a halted state. Contactless charging is halted by switching OFF the switch 45 connected between the charging circuit 50 and the internal batteries 1. The control circuit 40 holds the switch 45 OFF to halt contactless charging during the time period when external power source 120 connection or charging is being detected.

When the control circuit 40 charging pad detection section 41 detects placement on the charging pad 110 and the external power source detection section 42 detects external power source 120 connection or charging, the charging selection section 43 sends a halt-charging-signal to the charging pad 110 to halt charging by the charging pad 110, and charges the internal batteries 1 with the external power source 120. When the battery pack 10 is not placed on the charging pad 110 and the external power source 120 is connected, the internal batteries 1 are charged by the external power source 120. When the battery pack 10 is not placed on the charging pad 110, there is no need to detect external power source 120 connection or charging with the external power source detection section 42. This is because the internal batteries 1 can be charged under ideal conditions by the external power source 120. Since the external power source detection section 42 only detects external power source 120 connection or charging when the battery pack 10 is placed on the charging pad 110, it is not necessary for the external power source detection section 42 to detect external power source 120 connection or charging when the battery pack 10 is not placed on the charging pad 110. Accordingly, a battery pack 10 that operates the control circuit 40 with power transmitted from the charging pad 110 only activates the control circuit 40 to detect external power source 120 connection and charging. However, the control circuit 40 charging pad detection section 41 and external power source detection section 42 could also be continuously operated to detect placement on the charging pad 110 and external power source 120 connection and charging. When this battery pack 10 is placed on the charging pad 110 and the external power source 120 is not connected, the control circuit 40 charges the internal batteries 1 from the charging pad 110, and when the battery pack 10 is not placed on the charging pad 110 and the external power source 120 is connected, the control circuit 40 charges the internal batteries 1 from the external power source 120.

The control circuit 40 in FIG. 14 holds a signal switch 55, which is connected in series with a parallel capacitor 54 connected in parallel with the receiving coil 5, ON to send a halt-charging-signal to the charging pad 110. The charging pad 110 detects connection of the parallel capacitor 54 to the receiving coil 5 and stops supplying AC to the transmitting coil 105. The control circuit 40 can also switch the signal switch 55 ON and OFF in a prescribed manner (instead of holding it in the ON state) to convey connection of the external power source 120 to the charging pad 110. In that case, the charging pad 110 detects ON and OFF switching of the signal switch 55 to detect external power source 120 connection and stops supplying AC to the transmitting coil 105. A system that stops the charging pad 110 from charging the internal batteries 1 by halting the input of AC to the transmitting coil 105 not only reduces unnecessary power consumption, but also prevents detrimental heating of the battery pack 10 by power output from the transmitting coil 105. However, when external power source 120 connection or charging is detected, AC output to the transmitting coil 105 does not necessarily have to be stopped, and the control circuit 40 in the battery pack 10 can also turn OFF the switch 45 to cut-off charging current to the internal batteries 1 and stop charging by the charging pad 110.

The rectifying circuit 51 rectifies AC power induced in the receiving coil 5 and outputs the rectified power to the control circuit 40. The battery pack 10 of FIG. 14 has a series capacitor 56 connected between the receiving coil 5 and the rectifying circuit 51, and AC power induced in the receiving coil 5 is input to the rectifying circuit 51 through that series capacitor 56. The series capacitor 56 forms a series resonant circuit with the receiving coil 5 to efficiently input AC power induced in the receiving coil 5 to the rectifying circuit 51. Accordingly, the capacitance of the series capacitor 56 is selected to combine with the receiving coil 5 inductance for an overall impedance having a minimum near the frequency of the induced AC power.

(DC/DC converter)

The DC/DC converter 58 stabilizes and outputs a constant voltage from the charged internal batteries 1. The circuit board 4 shown in the circuit diagram of FIG. 14 has a discharge switch 46 connected between the internal batteries 1 and the DC/DC converter 58. The discharge switch 46 is controlled ON and OFF by the control circuit 40. The control circuit 40 switches the discharge switch 46 ON and OFF according to signals from the push-button switch 16, which is activated by pressing the operating section 12. When an ON signal is input from the push-button switch 16 for a given length of time, the control circuit 40 switches the discharge switch 46 ON to output power from the internal batteries 1 to the DC/DC converter 58. Under these conditions, the DC/DC converter 58 is activated and supplies stabilized power to the output connectors 8 connected to its output-side. When portable electronic equipment 130 connected to an output connector 8 is disconnected from that output connector 8, the control circuit 40 can detect disconnection by the output current. This is because output current drops to OA when the portable electronic equipment 130 is disconnected.

As shown in FIG. 14, a protection circuit 47 that controls internal battery 1 charging and discharging is also mounted on the circuit board 4. The protection circuit 47 detects battery temperature and voltage and controls battery charging and discharging. Battery temperature is detected by temperature sensors 19 attached in a thermally coupled manner to the surfaces of the internal batteries 1. The temperature sensors 19 are connected to the protection circuit 47. The protection circuit 47 is provided with memory 48 that stores data for limiting battery charging and discharging current according to battery temperature. Memory 48 stores allowable current corresponding to battery temperature. Allowable current is the maximum current allowed to flow at a given temperature, and an operating current lower than that current is used. The protection circuit 47 protects the batteries by controlling battery charging and discharging current below the allowable current corresponding to battery temperature. In addition, the protection circuit 47 can store the maximum and minimum temperatures for battery charging and discharging, and can control charging and discharging to allow operation between the maximum and minimum temperatures. The maximum and minimum temperatures are set to appropriate values depending on the type of batteries. For example, for a lithium ion battery, the maximum temperature can be approximately 60° C. to 70° C. and the minimum temperature can be approximately −10° C. to 0° C.

Further, the protection circuit 47 controls charging and discharging by detecting the voltage of the internal batteries 1. The protection circuit 47 stops charging when battery voltage rises to a maximum voltage, and stops discharging when battery voltage drops to a minimum voltage. If the protection circuit 47 shown in FIG. 14 detects abnormal battery temperature or voltage, it controls the charging circuit 50 to stop charging the internal batteries 1 and controls the discharge switch 46 OFF to stop discharging the internal batteries

In the battery pack of FIG. 14, a discharge switch 46 is connected between the internal batteries 1 and the DC/DC converter 58. The discharge switch 46 is controlled ON and OFF by the control circuit 40. The control circuit 40 switches the discharge switch 46 ON and OFF according to signals from the push-button switch 16. When an ON signal is input from the push-button switch 16 for a given length of time, the control circuit 40 switches the discharge switch 46 ON to output power from the internal batteries 1 to the DC/DC converter 58. Under these conditions, the DC/DC converter 58 is activated and supplies stabilized power to the output connectors 8 connected to its output-side. If portable electronic equipment 130 connected to an output connector 8 is disconnected from that output connector 8, the control circuit 40 detects disconnection by the output current. This is because output current drops to OA when the portable electronic equipment 130 is disconnected.

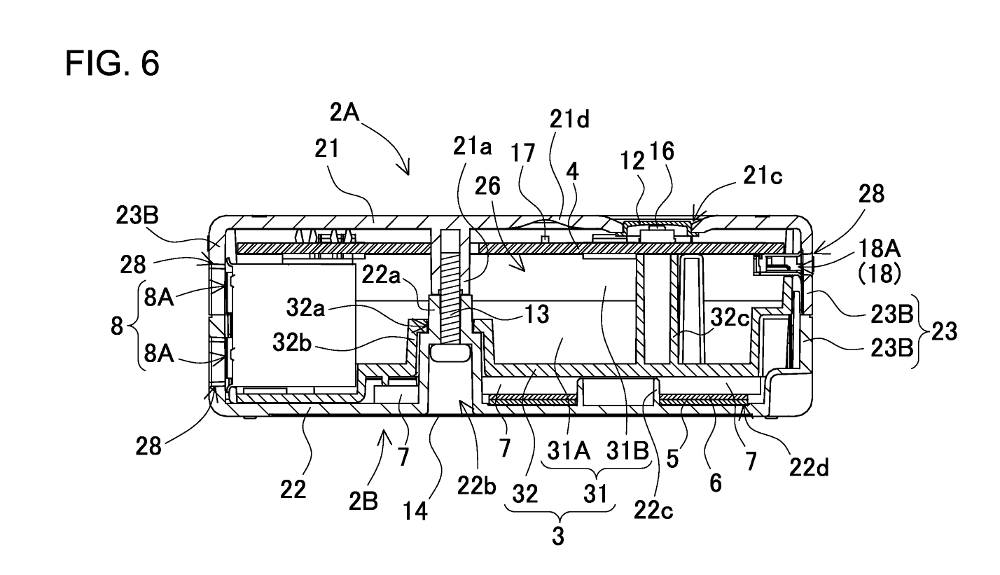

The battery pack shown in FIG. 14 also houses a remaining capacity detection circuit 49 to detect the remaining capacity of the internal batteries 1. The remaining capacity detection circuit 49 computes remaining capacity from internal battery 1 voltage and current, and indicates the remaining capacity by light emitting diode (LED) 17 illumination color or the number of devices illuminated. When an ON signal is received from the push-button switch 16, the remaining capacity detection circuit 49 illuminates the LEDs 17 for a given time period to indicate the remaining capacity. As shown in FIG. 6, the LEDs 17 are mounted on the circuit board 4 and controlled by the remaining capacity detection circuit 49 to display the remaining battery 1 capacity. The battery pack 10 has a top plate 21 covering the LEDs 17 that is made with light transmitting (translucent or transparent) plastic. In addition, the top plate 21 of the casing 2 shown in FIG. 6 is formed with a thin region over the LEDs 17 to establish a light transmitting region 21d that transmits LED 17 light to the outside. This casing 2 can display light emitted by the LEDs 17 to the outside without opening a hole to expose the LEDs 17. However, it is also possible to open a window in the casing and expose the LEDs to the outside.

Further, the charging circuit detects full-charge of the internal batteries 1 to halt charging. When the charging circuit 50 detects full-charge of the internal batteries 1, it sends a full-charge-signal to the charging pad 110. The charging pad 110 detects the full-charge-signal and halts charging.

### FIRST EMBODIMENT

The battery pack shown in FIGS. 4-13 has two internal batteries 1 disposed in the casing 2 storage space 25. The two batteries 1 housed in the casing 2 are circular cylindrical batteries 1A, and the circular cylindrical batteries 1A are disposed in the storage space 25 lying parallel to the bottom plate 22 along the inside surfaces of the side-walls 23A. This battery pack 10 has an internal battery 1 disposed on both sides of the storage space 25 establishing a heat dissipating region 26 between the pair of batteries 1.

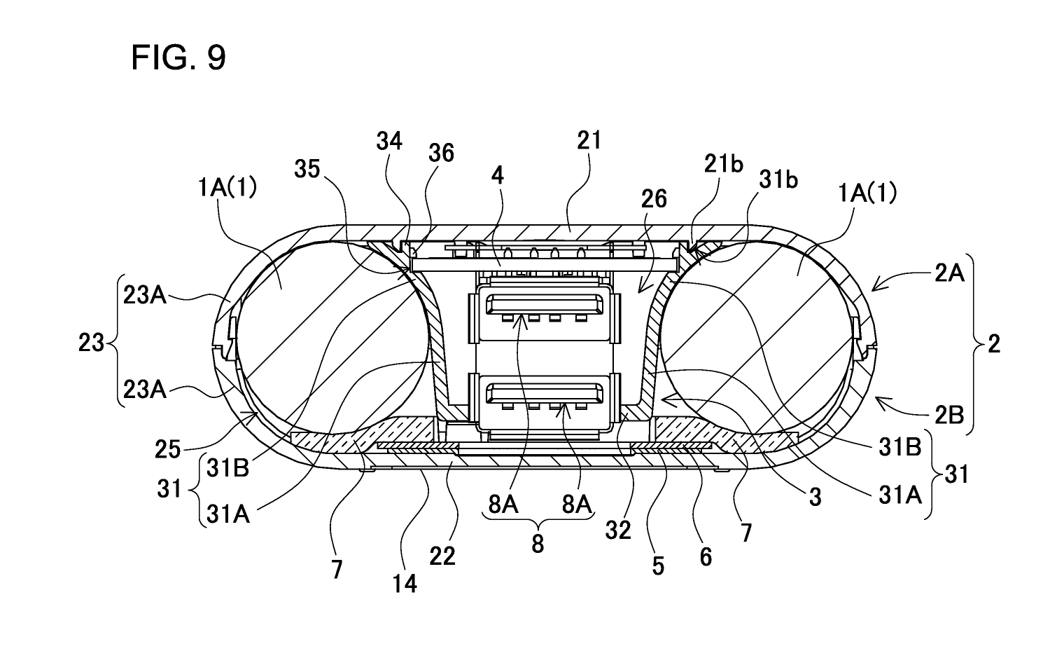

The battery pack 10 shown in FIGS. 4-13 houses a battery assembly 9 inside the casing 2. The battery assembly 9 is made up of the pair of circular cylindrical batteries 1A, the circuit board 4, and an insulating holder 3. The insulating holder 3 in the battery assembly 9 of this battery pack 10 is made of insulating material and disposes the pair of circular cylindrical batteries 1A in a separated and parallel manner to form the heat dissipating region 26 between the batteries. The circuit board 4, the circular cylindrical batteries 1A, and the receiving coil 5 are held in fixed positions by the insulating holder 3. The receiving coil 5 in the battery pack 10 of FIGS. 7 and 9 is disposed between the bottom peaks of the pair of internal batteries 1 held along the sides of the storage space 25.

(Casing)

The casing 2 holds the battery assembly 9 inside. The casing 2 in FIGS. 4-13 is made up of an upper case 2A and lower case 2B. The top plate 21 in the upper case 2A and the bottom plate 22 in the lower case 2B are rectangular, and the two internal batteries 1 are housed in parallel orientation between the top plate 21 and bottom plate 22. The perimeter walls 23 on both sides of the casing 2 are curved surfaces that conform to the surfaces of the internal batteries 1. The perimeter walls 23 of the casing 2 are made up of side-walls 23A on the two sides and end-panels 23B at both ends. The casing 2 of the figures has side-walls 23A that curve to fit with the surfaces of the internal batteries 1A and end-panels 23B that are planar. The upper case 2A and lower case 2B are molded from plastic in single-piece configuration with the perimeter walls 23 made up of the side-walls 23A and end-panels 23B.

The upper case 2A and lower case 2B join along the edges of the perimeter walls 23 to form an enclosed structure. The casing 2 of the figures has the upper case 2A and lower case 2B held together with a set screw 13. To enable the set screw 13 to be screwed into and hold the casing 2 together, the lower case 2B is provided with an insertion boss 22a that accepts insertion of the set screw 13 and is formed in single-piece construction protruding from the inside of the bottom plate 22. The upper case 2A is provided with an connection boss 21a that allows the set screw 13 to be screwed in and is formed in single-piece construction protruding from the inside of the top plate 21. The set screw 13 is inserted into the insertion boss 22a from an insertion recess 22b established in the outer surface of the lower case 2B, passed through the lower case 2B, and screwed into the connection boss 21 a to join the upper case 2A and lower case 2B. The perimeter walls 23 of the upper case 2A and lower case 2B can be positively joined at boundary edges by ultrasonic welding, bonding, or by a snap-together structure. Finally, a label 14 is adhered to the surface of the lower case 2B to externally hide the insertion recess 22b where the set screw 13 is inserted.

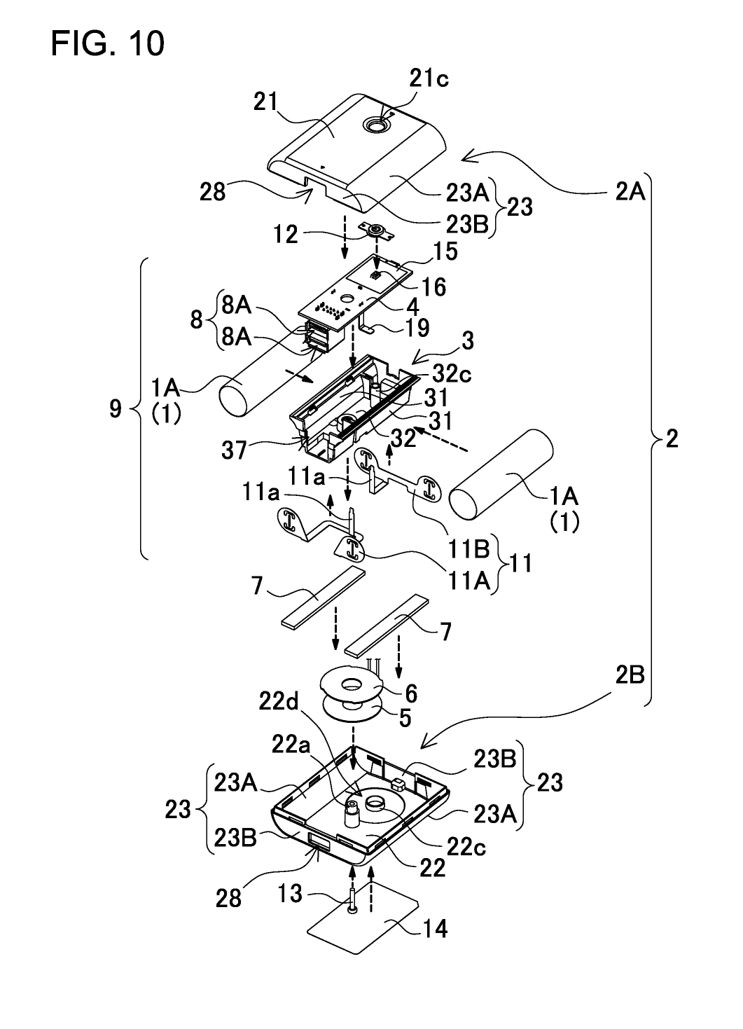

Further, the lower case 2B in FIG. 10 is provided with a circular cavity 22d in the inside surface of the bottom plate 22 and an alignment boss 22c formed in single-piece construction at the center of the circular cavity 22d to insert through the center-hole of the receiving coil 5 and dispose it in a fixed position on the bottom plate 22. The alignment boss 22c shown in the figures has a circular cylindrical shape that inserts through the center-holes of the receiving coil 5 and the shielding plate 6 to hold them in fixed positions.

The casing 2 has two connector windows 28 opened through the end-panel 23B at one end to externally expose a stack of two USB connectors 8A, and a single connector window 28 opened through the end-panel 23B at the other end to expose a single mini- or micro-USB connector 18A. In addition, the upper case 2A has a push-button window 21c opened through the top plate 21 to expose the operating section 12 that activates the push-button switch 16.

(Insulating Holder)

The insulating holder 3 disposes the circuit board 4 towards the top of the pair of circular cylindrical batteries 1A where the gap between the batteries 1 becomes wider, and disposes the output connectors 8 and input connector 18 in the heat dissipating region 26 between the circular cylindrical batteries 1A. As shown in FIGS. 7-9, the insulating holder 3 disposes the circuit board 4 below the uppermost tangent to the tops of the two circular cylindrical batteries 1A, and disposes the output connectors 8 and input connector 18 inward from the circuit board 4. The insulating holder 3 is made by molding insulating plastic. The insulating holder 3 is disposed at the center region of the casing 2 oriented with its lengthwise direction parallel to the casing 2 side-walls 23A. The insulating holder 3 is disposed between the end-panels 23B established at both ends of the casing 2 and prevented from shifting position in the lengthwise direction by the pair of end-panels 23B. Accordingly, the insulating holder 3 of FIGS. 6, and 10-13 has a total length equal to the distance between the insides of opposing end-panels 23B and is disposed between those end-panels 23B.

The circuit board 4 is disposed in a fixed position on the inside of the insulating holder 3, and the two internal batteries 1 are disposed on each side of the insulating holder 3. The insulating holder 3 in FIGS. 7-11 is formed as a single-piece from plastic with opposing side-walls 31 on both sides and a connecting plate 32 connecting the opposing side-walls 31. The opposing side-walls 31 are disposed in a parallel manner and have shapes that follow the contours of the internal batteries 1 positioned outside the opposing side-walls 31. The connecting plate 32 is disposed on the inside of the bottom plate 22 of the casing 2, and both sides of the connecting plate 32 connect with one edge of an opposing side-wall 31.

Each opposing side-wall 31 has a planar section 31A near the bottom plate 22 and a curved section 31B near the top plate 21, and one end of the planar section 31A is connected to the connecting plate 32. Specifically, the opposing side-walls 31 in FIGS. 7-11 have planar sections 31A at one end and curved sections 31B at the other end, and the planar sections 31A are connected to the connecting plate 32. Since the curved sections 31B curve to conform to the internal battery 1 surfaces, the distance between opposing curved sections 31B widens as the top plate 21 is approached. The circuit board 4 is connected on the top plate 21 side where the opposing curved sections 31B widen. By disposing the circuit board 4 between the curved sections 31B of an insulating holder 3 with this configuration, the curved sections 31B can hold a wide circuit board 4 carrying many electronic components while holding the internal batteries 1 in stable fixed locations. Further, electronic components can be mounted in a manner protruding from the inward facing surface (which is the surface that does not face the top plate 21) of the circuit board 4 mounted in this position. Electronic components mounted in this manner effectively utilize the space inward of the circuit board 4 and between the pair of opposing side-walls 31.

The circuit board 4 is connected on the inside of the pair of opposing side-walls 31 in an orientation parallel to the connecting plate 32. To hold the circuit board 4 in a fixed position, the pair of opposing side-walls 31 is provided with a pair of retaining ribs 34 positioned on both sides of the circuit board 4 protruding outward beyond the upper surface of the circuit board 4, and with steps 35 and latching hooks 36 on the inside surfaces of the retaining ribs 34. The latching hooks 36 are molded as a single-piece with the insulating holder 3. The edges on both sides of the circuit board 4 are inserted in the steps 35 to hold the circuit board 4 in a fixed position.

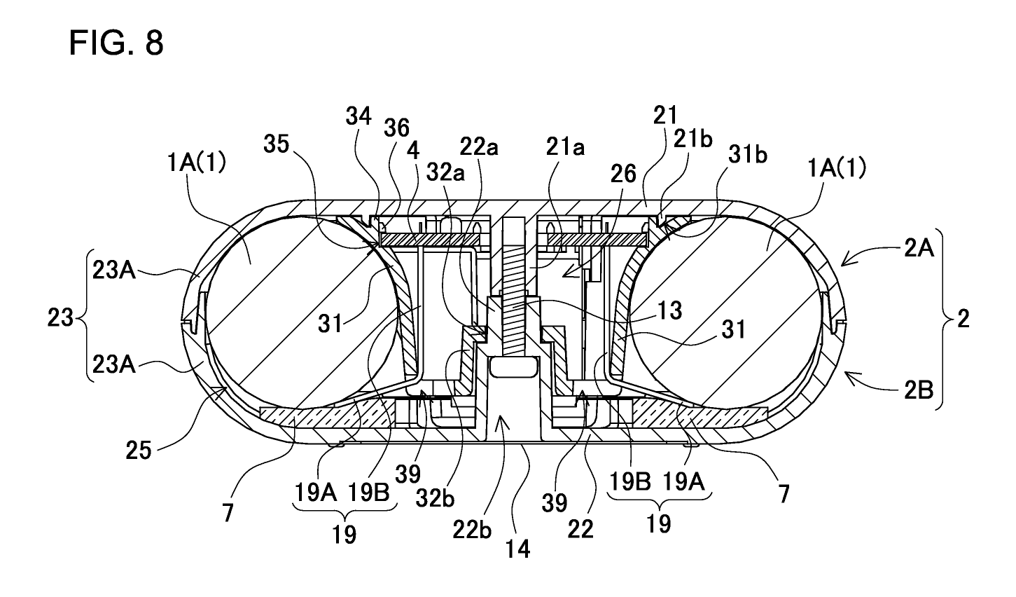

Further, as shown in FIGS. 8, 11, and 13, the insulating holder 3 is provided with openings 39 to pass temperature sensor 19 leads 19B. The temperature sensor 19 leads 19B are connected to the circuit board 4 disposed inside the insulating holder 3 opposing side-walls 31, and the openings 39 enable temperature sensor 19 temperature detection sections 19A to thermally couple with the internal batteries 1 disposed outside the insulating holder 3. The lead 19B of each temperature sensor 19 passes through an opening 39 and the temperature detection section 19A at the end of the lead 19B is put in thermal contact with the curved surface of an internal battery 1. Since two temperature sensors 19 thermally couple with the surfaces of the two internal batteries 1, the insulating holder 3 is provided with a pair of openings 39 to pass the leads 19 of both temperature sensors 19.

The temperature sensor 19 openings 39 are established on both sides of the connecting plate 32 in corner regions with the opposing side-walls 31. The temperature sensor 19 leads 19B that pass through the openings 39 are flexible and can bend resiliently. Temperature sensor 19 leads 19B are mounted perpendicular to the circuit board 4, extend vertically along the inside surfaces of the planar sections 31A of opposing side-walls 31, and pass through the openings 39. The temperature sensor 19 leads 19B pass outside the insulating holder 3 openings 39 and are bent towards the surfaces of the internal batteries 1 to put the temperature detection sections 19A in close proximity with the surfaces of the internal batteries 1. Further, the temperature sensor 19 temperature detection sections 19A are pressed by the cushion material 7 disposed between the receiving coil 5 and the circular cylindrical batteries 1A to hold the temperature detection sections 19A in fixed positions thermally coupled with the internal batteries 1. Consequently, temperature detection sections 19A at the ends of the leads 19B, which pass through the openings 39, can be reliably put in contact with, and thermally coupled to the surfaces of the internal batteries 1. However, it is not always necessary to press the temperature detection sections against the internal battery surfaces with cushion material, and the temperature detection sections can also be put in close contact with the internal battery surfaces and thermally coupled to the battery surfaces via thermal paste (such as heat sink paste).

Further, to connect the insulating holder 3 in a fixed position inside the casing 2, the casing 2 and the opposing side-walls 31 are configured to fit together. The top plate 21 of the casing 2 is configured with positioning rails 21b and the opposing side-walls 31 of the insulating holder 3 are configured with positioning grooves 31b. The positioning rails 21b insert into the positioning grooves 31b to dispose the insulating holder 3 in a fixed position inside the casing 2. The positioning grooves 31 b are established in the edges at the ends of the curved sections 31B of the insulating holder 3 opposing side-walls 31 that contact the top plate 21. The insulating holder 3 shown in FIGS. 7-9 is provided with positioning grooves 31b extending in the lengthwise direction in the outside edges of the retaining ribs 34 at the ends of the curved sections 31B. The positioning rails 21b that insert into the positioning grooves 31b are established protruding from the inside surface of the top plate 21. The positioning rails 21b are formed as long narrow projecting rails to fit together with channel-shaped positioning grooves 31b.

In addition, an alignment hole 32a is established in the insulating holder 3 to hold it in a fixed position in the casing 2. The alignment hole 32a is established in the connecting plate 32 of the insulating holder 3. The connecting plate 32 is also provided with an alignment boss 32b formed in single-piece construction protruding from the inside surface of the connecting plate 32, and the alignment hole 32a is established at the center of that alignment boss 32b. The alignment hole 32a disposes the insulating holder 3 in a fixed position inside the casing 2 and is established in a location where the casing 2 insertion boss 22a can pass through it. The casing 2 insertion boss 22a inserts through the alignment hole 32a opened at the center of the alignment boss 32b to dispose the insulating holder 3 in a fixed position inside the casing 2. Accordingly, the inside diameter of the alignment hole 32a is made approximately equal to the outside diameter of the insertion boss 22a to form a structure that can hold the insulating holder 3 in a fixed position inside the casing 2 by inserting the insertion boss 22a through the alignment hole 32a.

As shown in FIGS. 6 and 7, the battery pack 10 exposes the operating section 12 that activates the push-button switch 16 from the push-button window 21c in the top plate 21. The operating section 12 pushes the push-button switch 16 mounted on the circuit board 4 to switch it ON and OFF. As shown in FIG. 14, the push-button switch 16 outputs a display-signal to the internal battery 1 remaining capacity detection circuit 49 mounted on the circuit board 4 to display the remaining battery capacity. The remaining capacity detection circuit 49 displays internal battery 1 remaining capacity by the state of illumination or color of the LEDs 17. When the remaining capacity detection circuit 49 receives a display-signal from the push-button switch 16, it illuminates the LEDs 17 for a given time period to display the remaining battery capacity.

The push-button switch 16 can also switch the operating state of the DC/DC converter 58. In a battery pack 10 that displays remaining battery capacity and also switches the operating state of the DC/DC converter 58 with ON and OFF signals from the push-button switch 16, remaining capacity can be displayed by quickly pressing the push-button switch 16, and the operating state of the DC/DC converter 58 can be switched by pressing the push-button switch 16 for a longer period. When an ON signal is input from the push-button switch 16 for a period judged to be longer than a set time, the operating state of the DC/DC converter 58 is switched. Since this battery pack 10 can maintain the DC/DC converter 58 in an OFF state when the push-button switch 16 is not held pressed for long period, unnecessary battery consumption can be prevented when portable electronic equipment 130 is not connected to an output connector 8. This is because the DC/DC converter 58 consumes power in the operating state even when portable electronic equipment 130 is not connected as a load.

The insulating holder 3 of the figures is provided with a supporting boss 32c molded in single-piece construction on the connecting plate 32 and located under the push-button switch 16 mounted on the circuit board 4 to support the underside of the circuit board 4. Since this supporting boss 32c configuration supports the circuit board 4 under the push-button switch 16, the push-button switch 16 can be reliably activated by lightly pressing the operating section 12.

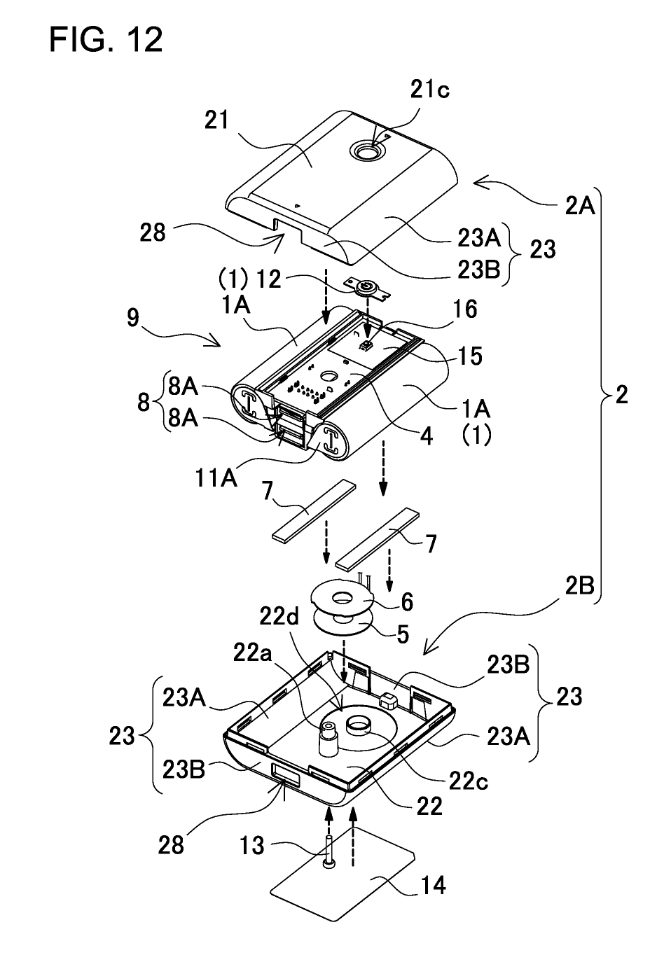

The circuit board 4 shown in FIGS. 10 and 12 has a flexible, light blocking insulating sheet 15 disposed on the surface under the operating section 12. The insulating sheet 15 has an opening, and is disposed with the push-button switch 16 exposed through that opening. Material such as polyester plastic can be used as the insulating sheet 15. The insulating sheet 15 serves as static discharge protection by lengthening the discharge path for static electricity while preventing illuminated LEDs 17 inside the casing 2 from shining light outside through the push-button window 21c.

(Lead-Plates)

As shown in FIGS. 10-13, the pair of internal batteries 1 is connected to the circuit board 4 via positive and negative electrode terminal lead-pates 11. The two internal batteries 1 shown in the figures have a first lead-pate 11A connected to the pair of electrode terminals at one end, and a second lead-pate 11B connected to the pair of electrode terminals at the other end. Specifically, the lead-plates 11 connect the two internal batteries 1 to the circuit board 4 in parallel. However, two circular cylindrical batteries can also be connected in series.

Each lead-plate 11 of the figures is configured with a connecting section that joins contact sections that contact the electrode terminals. The first lead-pate 11A is connected to the electrode terminals at the end where the stack of two USB connectors 8A is disposed. To avoid contact with the stack of USB connectors 8A, the connecting section of the first lead-pate 11A bends at the base, has a U-shape that runs around the perimeter of the bottom of the USB connectors 8A, and is disposed on the outside of insulating holder 3 connecting plate 32. Further, a connecting tab 11a on the connecting section of the first lead-pate 11A passes through a slit 38 opened through the insulating holder 3 and is connected to the circuit board 4. The second lead-pate 11B is connected to the electrode terminals at the opposite end from the stack of two USB connectors 8A. To avoid contact with the single mini- or micro-USB connector 18A, the connecting section of the second lead-pate 11B is disposed on the lower part of the end of the insulating holder 3. Further, the connecting section of the second lead-pate 11B has a connecting tab 11a disposed on the bottom surface of the insulating holder 3 connecting plate 32 that bends to pass through another slit 38 established in the insulating holder 3 and connect to the circuit board 4.

(Output Connector, Input Connector)

The output connectors 8 and input connector 18 are mounted on the circuit board 4 and disposed in the heat dissipating region 26 established between the internal batteries 1. FIGS. 6, 9, and 10-13 show USB connectors 8A that are the output connectors 8 and the mini- or micro-USB connector 18A that is the input connector 18 disposed in fixed positions. The circuit board 4 in these figures has standard USB connectors that are the output connectors 8 mounted at one end, and a mini- or micro-USB connector 18A that is the input connector 18 mounted at the other end. The output connectors 8 and the input connector 18 are mounted on the circuit board 4 by soldering. The output connectors 8 and input connector 18 have a plurality of pins that insert into the circuit board 4 and make mechanical connection. The pins are soldered to conducting regions of the circuit board 4 to attach them to the circuit board 4 and make electrical connection. This circuit board 4 has a stack of two USB connectors 8A, which are standard USB connectors, solder-attached at one end, and a mini- or micro-USB connector 18A solder-attached at the other end. The output connectors 8 and input connector 18 are disposed at the ends of the circuit board 4, and USB plugs insert into those connectors through connector windows 28 in the casing 2. The stack of two USB connectors 8A mounted on the circuit board 4 fits into a cavity 37 established in the insulating holder 3, and the USB connector 8A stack is disposed in that cavity 37 to retain it in a fixed position in the insulating holder 3.

The battery pack 10 of the embodiment described above houses a pair of circular cylindrical batteries 1A inside a casing 2. However, the battery pack of the present invention can also house a single circular cylindrical battery inside a casing. The following describes in detail an embodiment of a battery pack housing a single circular cylindrical battery. In the following embodiment, structural elements that are the same as the previous embodiment have the same label and their detailed description is abbreviated.

### SECOND EMBODIMENT

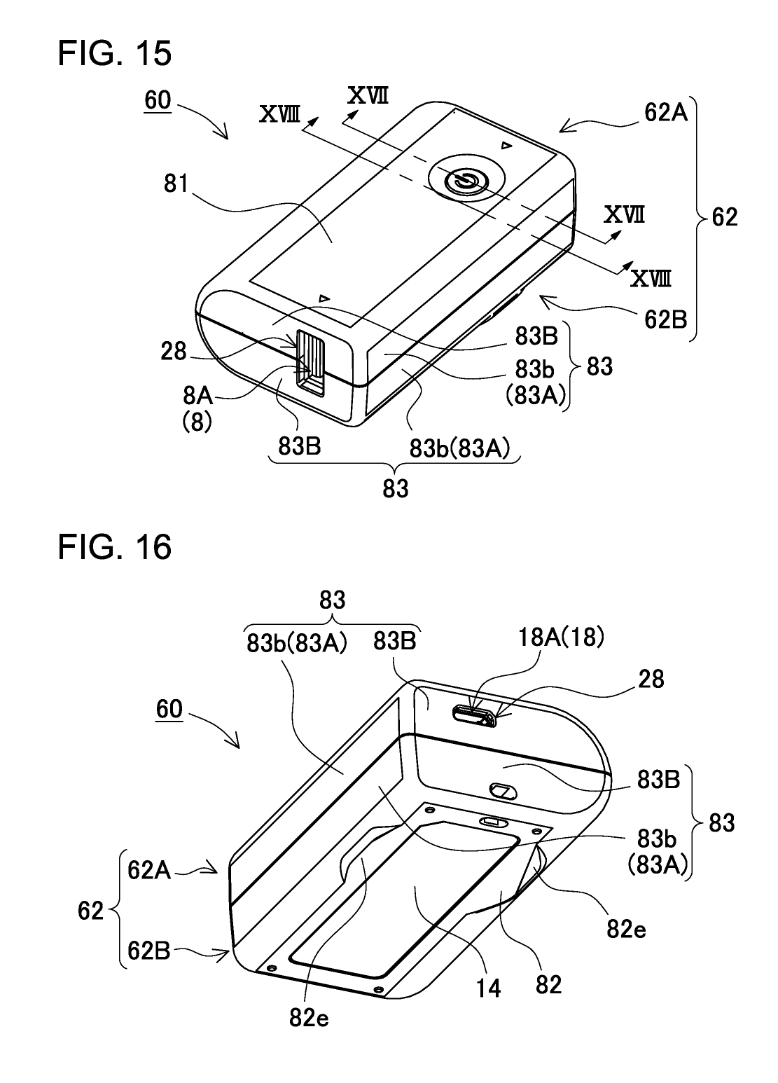

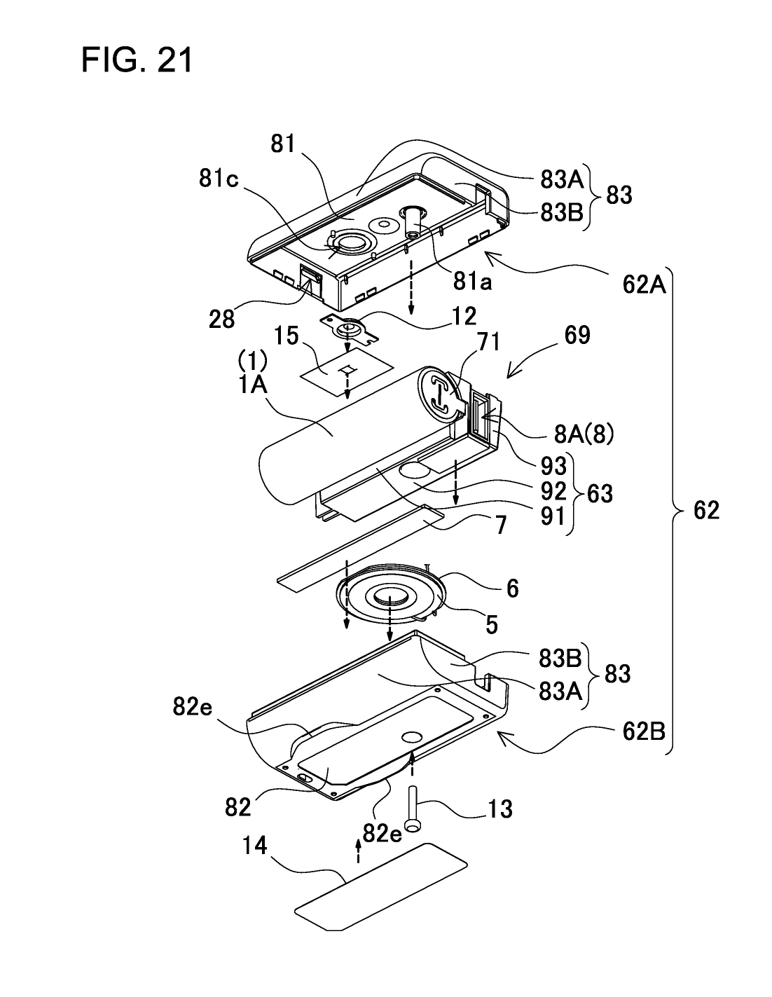

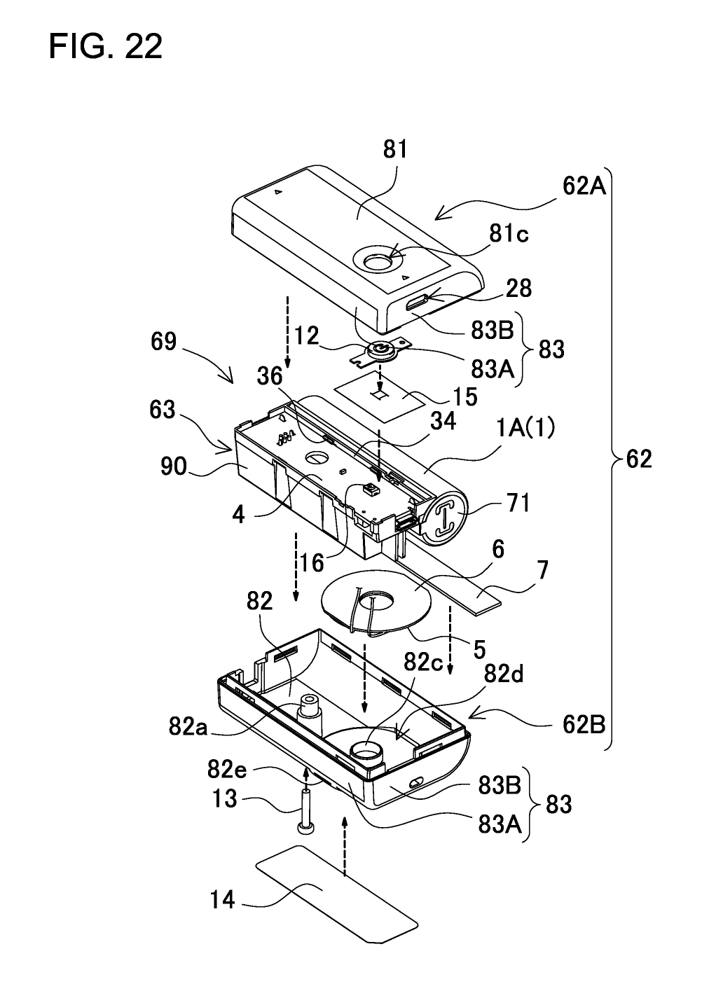

The battery pack 60 shown in FIGS. 15-22 has a single internal battery 1 disposed in the casing 62 storage space 85. The battery 1 housed in the casing 62 is a circular cylindrical battery 1A, and the circular cylindrical battery 1A is disposed in the storage space 85 lying parallel to the bottom plate 82 along the inside surface of the side-wall 83A on one side. This battery pack 60 has the internal battery 1 disposed on one side of the storage space 25 establishing a heat dissipating region 86 to the side of the battery 1.

The battery pack 60 shown in FIGS. 15-22 houses a battery assembly 69 inside the casing 62. The battery assembly 69 is made up of the circular cylindrical battery 1A, the circuit board 4, and an insulating holder 63. The casing 62 of this battery pack 60 has one side-wall 83A separated by a given distance from the circular cylindrical battery 1A, and the insulating holder 63 made of insulating material is disposed between the battery 1 and the separated side-wall 83A to establish a heat dissipating region 86. The circuit board 4, the internal battery 1, and the receiving coil 5 are held in fixed positions by the insulating holder 63.

(Casing)

The casing 62 is configured with a top plate 81 and bottom plate 82 surrounded by perimeter walls 83 that hold the battery assembly 69 inside. The casing 62 in FIGS. 15-22 is made up of an upper case 62A and lower case 62B. The casing 62 holds the circular cylindrical battery 1A in one side and holds the circuit board 4, the output connector 8, and the input connector 18 in the other side. The perimeter walls 83 of the casing 62 are made up of side-walls 83A on the two sides and end-panels 83B at both ends. The casing 62 side-walls 83A are made up of a curved side-wall 83a on one side that curves to follow the surface of the circular cylindrical battery 1A, and vertical side-wall 83b on the other side that is a vertical surface. The upper case 62A and lower case 62B join along the edges of the perimeter walls 83 to form an enclosed structure.

The casing 62 of the figures has the upper case 62A and lower case 62B held together with a set screw 13. To enable the set screw 13 to be screwed into and hold the casing 62 together, the lower case 62B is provided with an insertion boss 82a that accepts insertion of the set screw 13 and is formed in single-piece construction protruding from the inside of the bottom plate 82. The upper case 62A is provided with an connection boss 81a that allows the set screw 13 to be screwed in and is formed in single-piece construction protruding from the inside of the top plate 81. The set screw 13 is inserted into the insertion boss 82a from an insertion recess 82b established in the outer surface of the lower case 62B, passed through the lower case 62B, and screwed into the connection boss 81a to join the upper case 62A and lower case 62B. A label 14 is adhered to the surface of the lower case 62B to externally hide the insertion recess 82b where the set screw 13 is inserted.

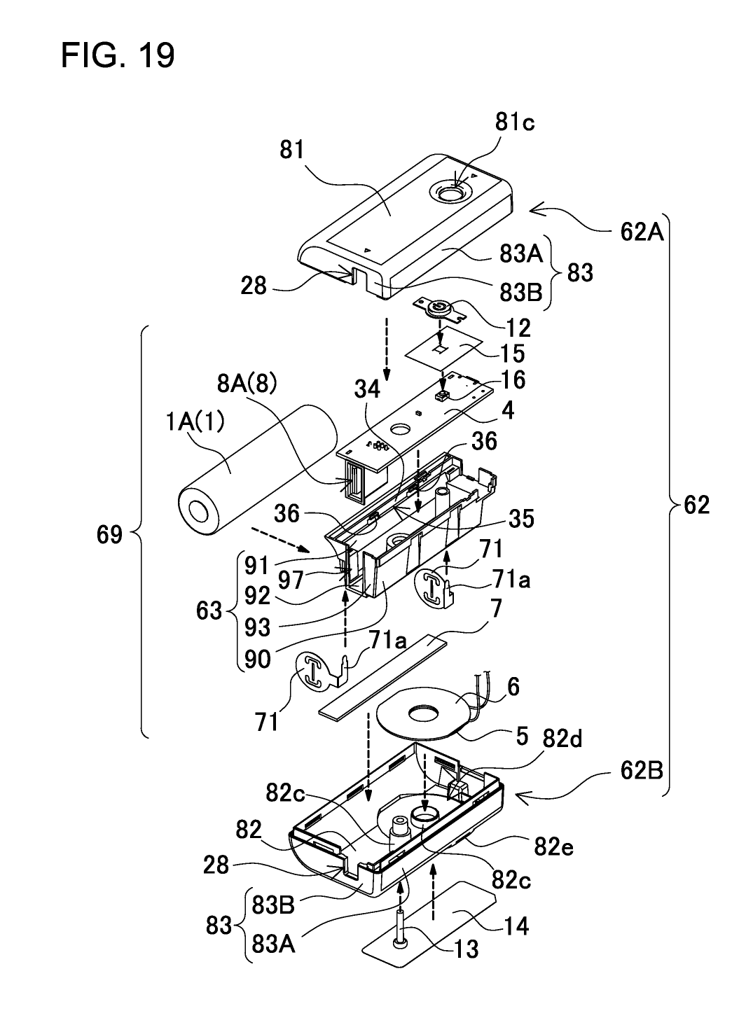

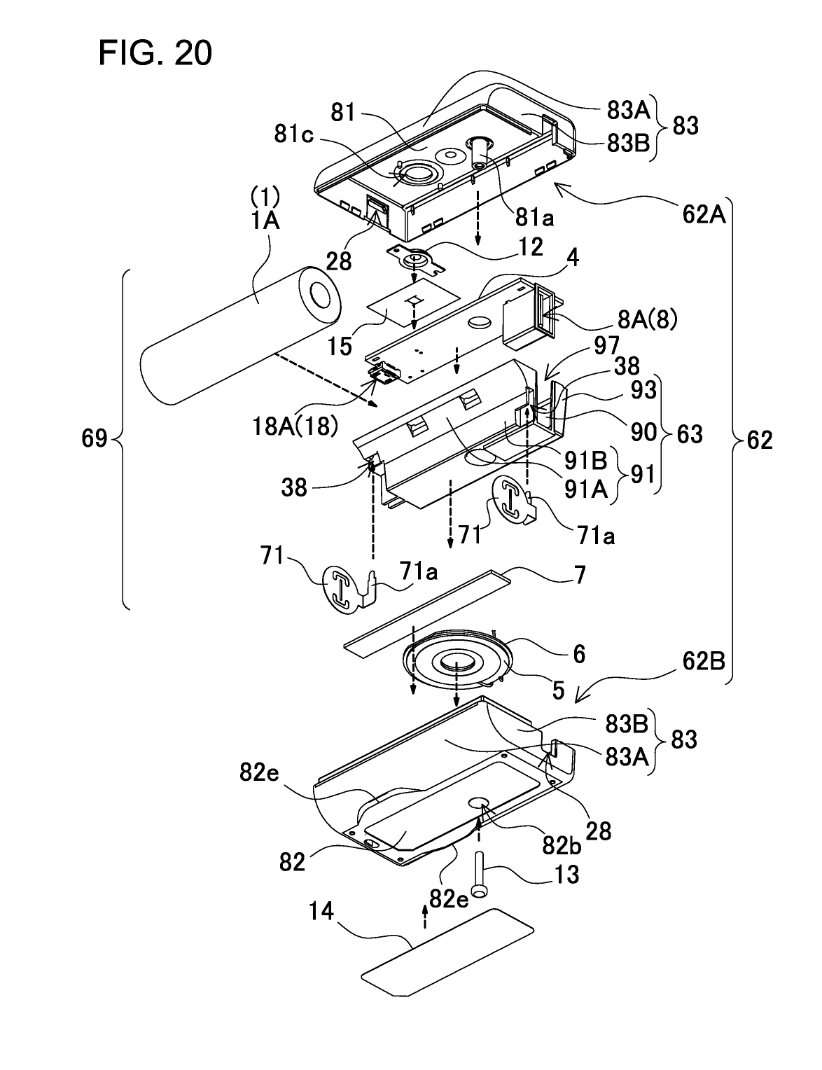

Further, the lower case 62B in FIG. 19 is provided with a circular cavity 82d in the inside surface of the bottom plate 82 and an alignment boss 82c formed in single-piece construction at the center of the circular cavity 82d to insert through the center-hole of the receiving coil 5 and dispose it in a fixed position on the bottom plate 82. The alignment boss 82c shown in the figures has a circular cylindrical shape that inserts through the center-holes of the receiving coil 5 and the shielding plate 6 to hold them in fixed positions. In addition, the lower case 62B shown in FIG. 20 has a circular protrusion 82e that extends out from both sides of the bottom surface around the outline of the circular cavity 82d and allows the receiving coil 5, which is disposed on the bottom plate 82, to have a larger diameter. Since the receiving coil 5 is disposed inside this circular protrusion 82e, it also serves as a marker to show the position of the receiving coil 5 when the battery pack 60 is placed on the charging pad 110.

The casing 62 has a connector window 28 opened through the end-panel 83B at one end to externally expose a USB connector 8A, which is an output connector 8, and a connector window 28 opened through the end-panel 83B at the other end to externally expose a mini- or micro-USB connector 18A, which is an input connector 18. In addition, the upper case 62A has a push-button window 81 c opened through the top plate 81 to expose the push-button switch 16 operating section 12.

(Insulating Holder)

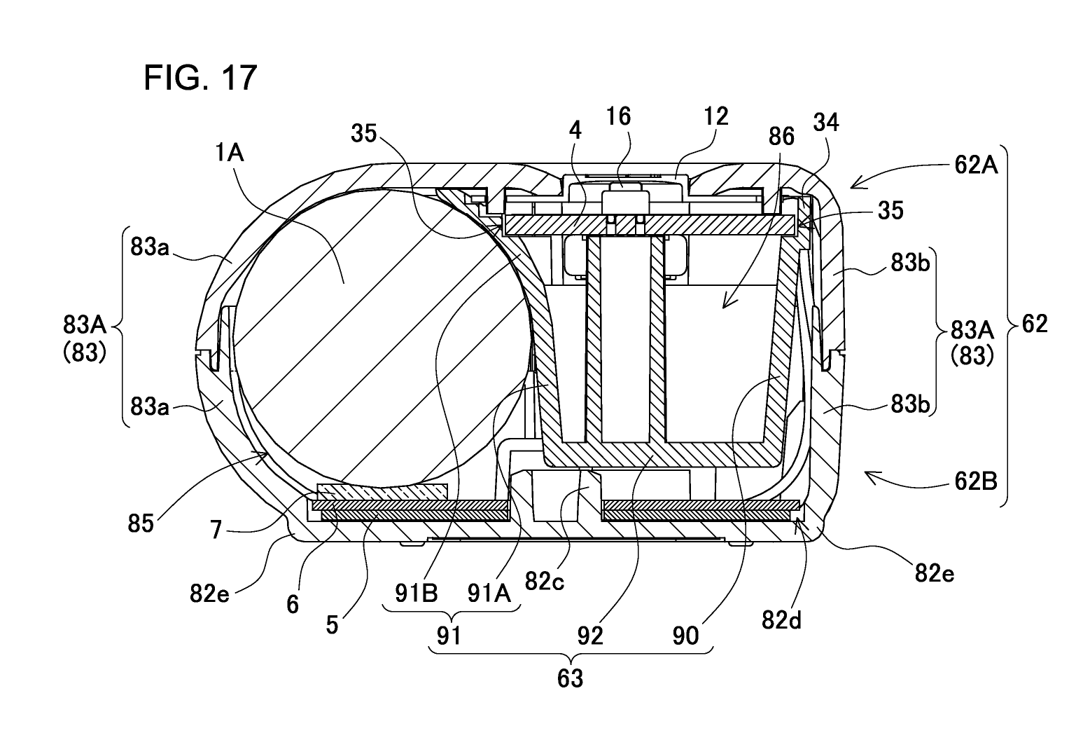

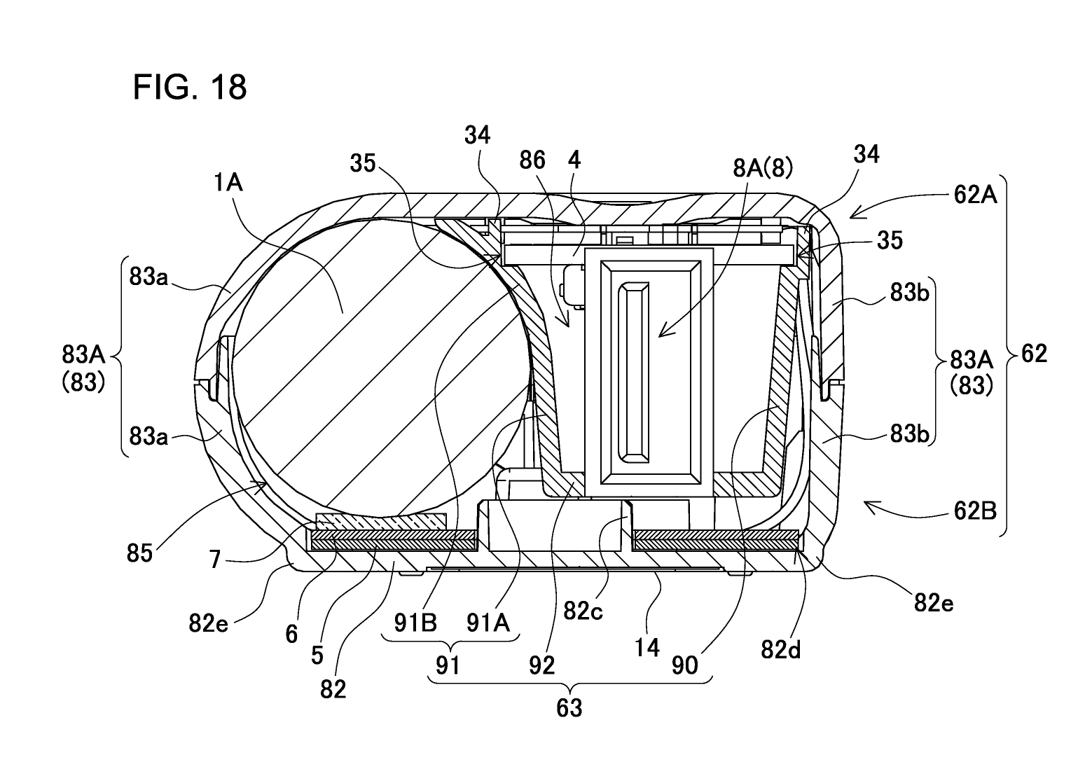

The insulating holder 63 is disposed in one side of the casing 62 between the circular cylindrical battery 1A and the vertical side-wall 83b of the side-walls 83. The insulating holder 63 disposes the circuit board 4 in the outer region where gap between the internal battery 1 and the vertical side-wall 83b becomes wider, and disposes the output connector 8 and input connector 18 in the heat dissipating region 86 inward from the circuit board 4. As shown in FIGS. 17 and 18, the insulating holder 63 disposes the circuit board 4 below the a horizontal line tangent to the top of the circular cylindrical battery 1A, and disposes the output connector 8 and input connector 18 inward from the circuit board 4. The insulating holder 63 is made by molding insulating plastic. The insulating holder 63 is disposed in one side of the casing 62 oriented with its lengthwise direction parallel to the casing 62 side-walls 83A. The insulating holder 63 is disposed between the end-panels 83B established at both ends of the casing 62 and prevented from shifting position in the lengthwise direction by the pair of end-panels 83B. Accordingly, the insulating holder 63 of the figures has a total length equal to the distance between the insides of opposing end-panels 83B and is disposed between those end-panels 83B.

The circuit board 4 is disposed in a fixed position on the inside of the insulating holder 63, and the internal battery 1 is disposed on one side of the insulating holder 63. The insulating holder 63 in FIGS. 17 and 18 is formed as a single-piece from plastic with a battery side-wall 91 that follows the surface of the circular cylindrical battery 1A, a casing side-wall 90 that conforms to the vertical side-wall 83b on one side of the casing 62, a connecting plate 92 that connects the battery side-wall 91 and the casing side-wall 90, and end-plates 93 established at both ends of the battery side-wall 91, the casing side-wall 90, and the connecting plate 92. The battery side-wall 91 and the casing side-wall 90 are disposed in a parallel manner. The battery side-wall 91 is shaped to follow the contour of the circular cylindrical battery 1A disposed on the outside of the battery side-wall 91. The casing side-wall 90, which faces the vertical side-wall 83b of the casing 62, is shaped to conform to the inside surface of the vertical side-wall 83b. The connecting plate 92 is disposed on the inside of the bottom plate 82 of the casing 62 and is connected to one edge of the battery side-wall 91 and to one edge of the casing side-wall 90. The end-plates 93 are established to connect the ends of the battery side-wall 91, the casing side-wall 90, and the connecting plate 92. Since the insulating holder 63 of the figures has a USB connector 8A, which is a standard USB connector, disposed at one end and a mini- or micro-USB connector 18A disposed at the other end, open regions are established in the end-plates 93 at both ends to expose the USB connector 8A and the mini- or micro-USB connector 18A.

The battery side-wall 91 has a planar section 91A near the bottom plate 82 and a curved section 91B near the top plate 81, and one end of the planar section 91A is connected to the connecting plate 92. Specifically, the battery side-wall 91 shown in FIGS. 17 and 18 has a planar section 91A at one end and a curved section 91B at the other end, and the planar section 91A is connected to the connecting plate 92. Since the curved section 91 B curves to conform to the surface of the internal battery 1, the inside width of the insulating holder 63 widens as the top plate 81 is approached. The circuit board 4 is connected at the top plate 81 end of the curved section 91 B where the inside of the insulating holder 63 becomes wider.

The casing side-wall 90 is an inclined surface that inclines from the bottom plate 82 towards the top plate 81 in a manner that narrows the gap between the insulating holder 63 casing side-wall 90 and the vertical side-wall 83b, which is a side-wall 83A of the casing 62. The bottom plate 81 side of the casing side-wall 90 is connected to the connecting plate 92. Specifically, the casing side-wall 90 shown in FIGS. 17 and 18 inclines to widen the inside of the insulating holder 63 towards the top plate 81. The circuit board 4 is connected at the top plate 81 end of the inclined casing side-wall 90 where the inside of the insulating holder 63 widens. However, it is not always necessary to make the casing side-wall 90 an inclined surface, and it can also be made as a vertical surface or curved surface.

The circuit board 4 is connected on the inside surfaces of the battery side-wall 91 and casing side-wall 90 in an orientation parallel to the connecting plate 92. As shown in FIGS. 17-19, the battery side-wall 91 and casing side-wall 90 are provided with a pair of retaining ribs 34 positioned on both sides of the circuit board 4 protruding outward beyond the upper surface of the circuit board 4 to hold it in a fixed position. Steps 35 and latching hooks 36 are established on opposing inside surfaces of the retaining ribs 34.

(Lead-Plates)

As shown in FIGS. 19-22, the positive and negative electrode terminals of the internal battery 1 are connected to the circuit board 4 via lead-pates 71. Each lead-pate 71 is made up of a contact section that connects with a battery electrode terminal and a connecting tab 71a that connects the contact section to the circuit board 4. The lead-pates 71 are disposed at the ends of the insulating holder 63 with contact sections in contact with the two electrode terminals of the internal battery 1 and connecting tabs 71a passed through slits 38 established in the insulating holder 63 to connect to the circuit board 4.

(Output Connector, Input Connector)

The output connector 8 and input connector 18 are mounted on the circuit board 4 and disposed in the heat dissipating region 86 established between the internal battery 1 and the vertical side-wall 83b. FIGS. 19 and 20 show the USB connector 8A that is the output connector 8 and the mini- or micro-USB connector 18A that is the input connector 18 disposed in fixed positions. The circuit board 4 in these figures has a standard USB connector that is the output connector 8 mounted at one end, and a mini- or micro-USB connector 18A that is the input connector 18 mounted at the other end. The output connector 8 and input connector 18 are disposed at the ends of the circuit board 4, and USB plugs insert into those connectors through connector windows 28 in the casing 62. The USB connector 8A and mini- or micro-USB connector 18A are mounted on the circuit board 4 by soldering. The USB connector 8A and mini- or micro-USB connector 18A have a plurality of pins that insert into the circuit board 4 and make mechanical connection. The pins are soldered to conducting regions of the circuit board 4 to attach them to the circuit board 4 and make electrical connection.

Further, the USB connector 8A shown in FIGS. 18-22 is mounted on the circuit board 4 in an orientation that positions a narrow edge of the rectangular USB plug insertion opening opposite the surface of the circuit board 4. Specifically, the USB connector 8A is mounted on the circuit board 4 in an orientation that puts the long edges (the lengthwise direction) of the USB connector 8A, which is a standard USB connector, parallel to the vertical side-wall 83b of the casing 62. As shown in FIG. 18, this structure allows the heat dissipating region 86 between the internal battery 1 and the vertical side-wall 83b to be made narrower. In other words, this structure allows a standard USB connector 8A to be disposed in a fixed position while enabling the overall battery pack outline to be made compact. The USB connector 8A mounted on the circuit board 4 fits into a cavity 97 established in the insulating holder 63, and the USB connector 8A is disposed in that cavity 97 to retain it in a fixed position in the insulating holder 63. It should be apparent to those with an ordinary skill in the art that while various preferred embodiments of the invention have been shown and described, it is contemplated that the invention is not limited to the particular embodiments disclosed, which are deemed to be merely illustrative of the inventive concepts and should not be interpreted as limiting the scope of the invention, and which are suitable for all modifications and changes falling within the spirit and scope of the invention as defined in the appended claims. The present application is based on Application No. 2011-88,617 filed in Japan on Apr. 12, 2011, the content of which is incorporated herein by reference.

What is claimed is:

1. A battery pack with output connectors that can be placed on a charging pad having a transmitting coil, which transmits charging power via magnetic induction, comprising:
a receiving coil that receives power from the transmitting coil when the battery pack is in place on the charging pad;
internal battery that is charged by power induced in the receiving coil;
output connectors for use of the battery pack as a power source to output internal battery power to the outside;
a circuit board carrying a charging circuit to charge the internal battery with power induced in the receiving coil; and
a casing to house the circuit board, the receiving coil, and the internal battery,
wherein the casing has a planar bottom plate for placement on the charging pad, a top plate disposed opposite and separated from the bottom plate, and perimeter walls made up of side-walls and end-panels along the sides and ends of the bottom plate and top plate; storage space is established in the region enclosed by the bottom plate, the top plate, and the perimeter walls; the internal battery, the receiving coil, and the circuit board are disposed in the storage space,
wherein the internal battery is circular cylindrical batteries disposed inside the storage space lying parallel to the bottom plate along the inside surfaces of the side-walls,
wherein the receiving coil is a planar coil disposed on the inside surface of the bottom plate, which is the bottom of the storage space, and
wherein the circuit board is disposed inside the top plate separated from the receiving coil, and a heat dissipating region is established inside the battery pack surrounded by the circuit board, the receiving coil, and the internal battery.

2. The battery pack with output connectors as cited in claim 1 wherein cushion material is disposed between the receiving coil and the circular cylindrical batteries.

3. The battery pack with output connectors as cited in claim 1 wherein the circuit board is disposed below the top of the internal battery, which is below the level of a line tangent to the tops of the circular cylindrical batteries.

4. The battery pack with output connectors as cited in claim 1 wherein the planar receiving coil is disposed outside the bottom of the internal battery, which is below the level of a line tangent to the bottoms of the circular cylindrical batteries.

5. The battery pack with output connectors as cited in claim 1 wherein a pair of internal battery is disposed in the storage space of the casing, and each battery is disposed in a side of the storage space to establish the heat dissipating region between the pair of internal battery.

6. The battery pack with output connectors as cited in claim 1 wherein a pair of internal battery is disposed in the sides of the casing storage space, and the receiving coil is disposed between peaks at the bottom of the internal battery.

7. The battery pack with output connectors as cited in claim 1 wherein a single internal battery is disposed in one side of the casing storage space, and the heat dissipating region is established on the other side of the internal battery.

8. The battery pack with output connectors as cited in claim 1 wherein a push-button switch is mounted on the upper surface of the circuit board, and an operating section to turn the push-button switch ON and OFF is provided in the top plate of the casing above the push-button switch.
